(19) United States
(12) Patent Application Publication
(10) Pub. No.: US 2025/0216123 A1
(43) Pub. Date: Jul. 3, 2025

(54) CONCENTRIC CHANNEL GROUND HEAT EXCHANGER

(71) Applicant: Applied Exponential Technologies, LLC, Park City, UT (US)

(72) Inventors: Kevin Peter MAHER, Park City, UT (US); Steven Thomas MAHER, North Andover, MA (US)

(73) Assignee: Applied Exponential Technologies, LLC, Park City, UT (US)

(21) Appl. No.: 18/867,171

(22) PCT Filed: May 30, 2023
(86) PCT No.: PCT/US2023/023884

§ 371 Date: Nov. 19, 2024

Related U.S. Application Data
(60) Provisional application No. 63/347,827, filed on Jun. 1, 2022.

(51) Int. Cl. F24T 10/17; F24T 10/00

(52) U.S. Cl. CPC F24T 10/17; F24T 2010/53; F24T 2010/56

(57) ABSTRACT

Systems and methods using fluid flow through concentric channels for ground heat exchange. A heat exchange system may be installed by inflating a flexible tube in a borehole. An accessible subsurface adaptor provides connections between the heat exchange features and laterals, as well as the ability to measure and monitor performance of the system.

### CROSS-REFERENCE TO RELATED APPLICATION

This application claims priority benefit of U.S. Provisional Application No. 63/347,827, filed Jun. 1, 2022, which is incorporated herein by reference in its entirety.

### TECHNICAL FIELD

Disclosed are embodiments related to heat exchange, and in particular, ground heat exchangers based on fluid flow.

### BACKGROUND

Geothermal energy is an abundant, naturally occurring, yet often overlooked renewable source. In geologic settings with high subsurface temperatures, for example, geothermal can be used for power generation (e.g., electricity and high-temp thermal) (GeoHT). In some locales, Geothermal Energy Exchange (GeoEE) can also be used with Ground Source Heat Pump (GSHP) technology to exchange energy with the subsurface for heating and cooling applications.

There remains a need for efficient heat exchange systems. Additionally, there remains a need for heat exchange systems that are easy to install, maintain, and/or repair.

### SUMMARY

According to embodiments, thermal loads can be transferred to one or more Ground Heat Exchangers (GHEX) in contact with the Earth using an Energy Exchange Fluid (EEF) flowing through the piping network of the GHEX(s) and connecting laterals. The EEF may be, for example, an aqueous fluid that circulates within a closed loop system. According to embodiments, one EEF is water, which may be de-ionized or may contain additives to inhibit freezing, corrosion, and biofouling.

According to embodiments, a system for heat exchange is provided that comprises a first tube, and a second tube arranged concentrically within the first tube. The first tube may be formed of a flexible material.

According to embodiments, a method is provided that comprises inserting a first tube into a borehole, and inflating the first tube to form a fluid channel. The first tube may be, for example, a flexible tube that conforms to an outer wall of the borehole wall upon inflating. In some embodiments, the first tube forms an outer fluid channel and the method further comprises inserting a second tube into the first tube to form an inner fluid channel.

According to embodiments, a heat exchanger adapter is provided that comprises: an outer shell, wherein the outer shell has a first fluid port and a second fluid port; and an internal spool assembly. The internal spool assembly may be removable.

According to some embodiments, a method in a ground heat exchanger having an adapter is provided, comprising: operating the ground heat exchanger using a first removable internal spool of the adapter; removing the first removable internal spool from the adapter; inserting a second removable internal spool into the adapter, wherein the second removable internal spool provides a different functionality than the first removable internal spool, and operating the ground heat exchanger using the second removable internal spool.

According to some embodiments, a heat exchange system is provided that comprises: a plurality of ground heat exchangers; a fluid distribution and control unit; and a plurality of pipes interconnecting the plurality of ground heat exchanges with the distribution and control unit.

According to some embodiments, a method of operating a plurality of ground heat exchangers is provided, comprising: performing active heat exchange with at least one of the ground heat exchangers; redistributing an energy exchange fluid within or between the plurality of ground heat exchangers; and resting at least one of the ground heat exchangers.

### BRIEF DESCRIPTION OF THE DRAWINGS

The accompanying drawings, which are incorporated herein and form part of the specification, illustrate various embodiments.

FIG. 1 is an illustration of a heat exchange system according to some embodiments.

FIGS. 2A and 2B illustrate a centralizer according to some embodiments.

FIGS. 3A-3D are figures and flow charts that illustrate processes according to some embodiments.

FIGS. 4 and 5 illustrate a heat exchange system according to some embodiments.

FIG. 6 is an illustration of a heat exchange system with an adapter assembly according to some embodiments.

FIGS. 7, 8A, 8B, 8C, 9, 10A, 10B, 11A, 11B, 11C, 11D, and 12 illustrate aspects of an adapter assembly according to some embodiments.

FIGS. 13, 14A, and 14B illustrate flushing tools according to some embodiments.

FIGS. 15A and 15B illustrate access tools according to some embodiments.

FIGS. 16-23 are plots illustrating operational and performance information according to some embodiments.

FIGS. 24, 25, and 26A are schematic diagrams that depict a heat exchange system and operation thereof according to embodiments.

FIG. 26B is a flow chart illustrating a process according to some embodiments.

FIGS. 27, 28, and 29 illustrate aspects of a vertically segmented heat exchange system according to some embodiments.

### INTRODUCTION

According to embodiments, thermal loads can be transferred to one or more Ground Heat Exchangers (GHEX) in contact with the Earth using an Energy Exchange Fluid (EEF) flowing through the piping network of the one or more GHEXs and connecting laterals.

Ground sourced heat pump (GSHP) technology and GeoEE offer an economical alternative to high-cost fossil fuels. Water-fed heat pumps can use a variety of thermal sources ranging from “open loop” designs where water from wells or surface water sources makes a single pass through a heat pump, to hybrid “standing column well” designs where water circulates within the same borehole while in direct contact with bedrock formation(s), to “closed loop” systems where EEF circulates within a sealed, continuous network of piping, ground heat exchangers, and the heat pump(s). However, “open loop” systems can suffer from poor water quality that fouls heat pumps or requires costly treatment and maintenance to avoid operational problems. There are also environmental concerns such as temperature driven changes, inadvertent contamination, and/or disruption to aquifer(s). Conversely, “closed loop” systems require less maintenance since they contain an EEF isolated from the environment. They can be installed at the bottom of ponds and lakes, or as shallow horizontal “slinky” GHEX closed loops in trenches where land is abundant, or as a series of vertical GHEXs installed in an array of well bores to constitute a “field”.

In certain respect, heat transfer in vertical ground heat exchangers may be controlled by two dynamics: (1) Borehole Resistance (Rb), which is the inhibition of heat transfer between the EEF and the borehole wall, and (2) Ground Response (Gr), which is the ability of the ground to transfer thermal energy between the borehole wall and the far-field geologic formation.

Borehole Resistance (Rb) may be understood as the thermal difference needed to drive a specific unit of heat between the EEF and the borehole wall. Even though Rb varies significantly between different GHEX designs, materials and backfills, it is a steady-state condition particular to each design. Rb can be defined, for example, as the rise of the Average Temperature [(EWT+LWT)/2] per the amount of heat exchanged per foot of the exchanger (BTU/HR-FT), less the temperature change associated with ground response (Gr), where the EWT is the entering water temperature and LWT is the leaving water temperature. Non-optimal Rb is typically a function of two factors—the inability of the GHEX design to efficiently transfer heat between the EEF and the borehole wall, and thermal leakage between the ascending flow channel and the descending channel, muting their temperature differential and dampening the benefit from GHEX contact with the formation. The Ground Response (Gr) may be understood as the thermal gradient required to drive a heat flux between the borehole wall and the surrounding formation. It is typically a function that varies over time and is dependent upon the diameter of the borehole and the formation's thermal conductivity (k) and diffusivity (a), which are independent and usually unaffected by GHEX design. Gr changes at a decreasing rate with increasing time as the applied heat flux moves outward into the formation.

These two factors (Rb and Gr) affect heat pump performance and the design of the GHEX system. Heat pumps operate best when there is minimal fluctuation in EWT over the course of an operating period. The less EWT fluctuation, the better the Coefficient of Performance (COP). Water presents a lower boundary condition of freezing that should also be considered in any GHEX design. Thermal Response Tests can be performed on GHEX test holes at prospective GeoEE sites to measure the ground conductivity/diffusivity and determine Rb as inputs for design. These parameters can be used to determine the overall length of GHEX required to accommodate a thermal load profile.

Existing GHEX designs have insufficient thermal performance and are difficult to fully inspect (or make repairs to) when buried in the ground. For instance, one practice is to install U-tubes constructed by joining two high-density polyethylene tubes (HDPE) at the bottom using a 180-degree fitting. The bore volume between the borehole wall and the installed U-tube(s) can be filled with grout to seal and prevent groundwater movement within the borehole. The grout may be enhanced with additives to improve its thermal conductivity. Additionally, U-tubes can be connected together in a parallel, reverse-return piping arrangement to create a circuit with improved flow capacities. However, such a system will lack pressure ports or sensors throughout to monitor conditions in the boreholes. Such U-tubes may also pose several additional challenges. For instance, they may become kinked or impinged during installation, creating a flow restriction. As another example, lateral lines often contain dirt and debris that enters during assembly. While the entire assembled circuit could be flushed to clear any debris, the debris would have to travel down to the bottom of the GHEX(s) and then return to the surface via the other leg. In this scenario, dirt and debris can become lodged or settle at the bottom of any U-tube and restrict flow. Another issue is that parallel piping provides multiple flow paths, and the EEF will always take the path of least resistance. Thus, changes in elevation of the reverse-return parallel piping may trap air pockets. If purge rates are insufficient to force any trapped air out of the system, then flow may be impeded to any GHEX located beyond. Since existing systems lack data on any individual U-tube/borehole, these flow restrictions are extremely difficult to locate and resolve. Finally, a flow restriction or impediment in one or more U-tubes requires the others to shoulder the load, resulting in a deviation from design performance.

Moreover, the boreholes and the entire lateral piping arrangement of existing systems are typically buried and may lie under a parking lot, a courtyard, a field or even a slab. While HDPE pipe is durable, it is not immune to leaking, which can occur from stresses due to movement from repeated heating and cooling, a puncture from an object buried alongside, or a failure at a heat-fused joint. When a leak occurs in a parallel, reverse-return circuit, it is nearly impossible to easily locate the area responsible and remediate. This requires re-excavation of the circuit (prohibitive) or its abandonment, losing considerable thermal capacity and orphaning GHEX/boreholes.

### DETAILED DESCRIPTION

According to embodiments, a heat exchange system is provided that addresses numerous issues with existing system. For instance, the increased volume and flow capacity provided by some embodiments can create significant opportunities to optimize operation and maximize energy exchange at lower costs. While a High Volume, High Flow Ground Heat Exchanger (HVHF-CGHEX) is used as an example, embodiments are applicable to other exchange systems, GHEXs, and related devices.

In some embodiments, a system is provided that uses a closed-loop, large diameter concentric design that eliminates many of the factors contributing to Borehole Resistance (Rb), and which reduces the amount of ground contact required to transfer a given thermal load. In some instance, the amount of required ground contact may be reduced by 35% or more. In certain aspects, the large volume of EEF held in the sub-surface can be further exploited using high flow rates with programmed cyclic exchange on either an individual exchanger or on a larger field, having a collection of two or more HVHF-CGHEX piped individually or small groupings to “centralized” distribution and control center(s). Flow and thermal energy exchange can be manually tuned, monitored with data loggers, and periodically adjusted or intelligently managed using real-time sensors/controls and programmable sequences which may be optimized using AI and ML. Lastly, in some embodiments, each device/well bore is surface accessible and serviceable throughout its lifecycle. Failed parts can be inspected, repaired, or replaced and this design also provides easy access to lateral piping to pinpoint the location of potential leaks without extensive excavation. These features of the HVHF-CGHEX, or other exchange system, can improve thermal exchange efficiency (TEE) while reducing life-cycle costs and systemic risk, making GeoEE a more practical and economical renewable energy resource.

In a first aspect, one or more borehole and GHEX designs are provided. Embodiments may fall into several categories of design.

For example, embodiments may be configured for competent, hard bedrock formations, with a large diameter outer tube constructed from flexible material that is placed in direct contact with the borehole wall providing a greater surface area for heat conduction. Because of its pliability, the tube once inflated, conforms tightly to the borehole wall, thereby inhibiting ground water movement along and within the borehole. This can, for example, eliminate the need for grout. In embodiments, the tube is relatively thin, yet strong, resulting in a minimal barrier for heat conduction between the circulating energy exchange fluid and the borehole wall.

As another example, some embodiments may be specially designed for loose, unconsolidated formations that are prone to sloughing or collapse during or after drilling. This may be addressed, for instance, with a large diameter casing (e.g., made from PVC, HDPE, mild steel, stainless steel, or others) that is installed in the larger drilled bore and then grouted in accordance with local or state regulations. Alternatively, the casing (e.g., steel, stainless steel, or others) may be driven, drilled or advanced by other means and may be in direct contact with the formation(s).

In certain aspects, both embodiments can be configured to store a greater volume of EEF underground as compared to other GHEX designs of similar depth. Additionally, both embodiments have an inner tube to create a second flow channel and complete the concentric design. Such a tube may be comprised of a variety of materials, like the ones mentioned above. In some embodiments, centralizers are used that are attached to the outside of the inner tube. The centralizers can keep the annular area concentric, and may also be fluted to facilitate mixing of the EEF during flowing conditions. In certain aspects, the diameter of the inner tube may be governed by considerations of flow rates, pressure drops, and transit time for the EEF.

In some embodiments, a large diameter design is used that design permits high flow at minimum pressures, which minimizes the thermal differential between the opposing flow channels while also increasing the heat flux between the EEF and the outer tube or casing. In some embodiments, a large diameter borehole is drilled to a specified depth. Some example diameters range from 4″ to greater than 18″, with the diameter being either 6″ or 8″ in some embodiments. Other diameters may be used. However, large diameters provide large storage volumes in the subsurface. In some embodiments, the inner and outer tubes have relative widths of approximately 2-3× (e.g., the outer tube is approximately 2-3 times as wide as the inner tube). However, different relative widths may be used. For instance, where one or more segmentation devices are used in the system, a wider outer tube may be used to accommodate any additional piping.

In certain aspects, the HVHF-CGHEX internal components are designed to be retrievable, repairable, or replaceable. This can preserve the long-term utility of the drilled borehole, which is often the most expensive component in a ground heat exchanger.

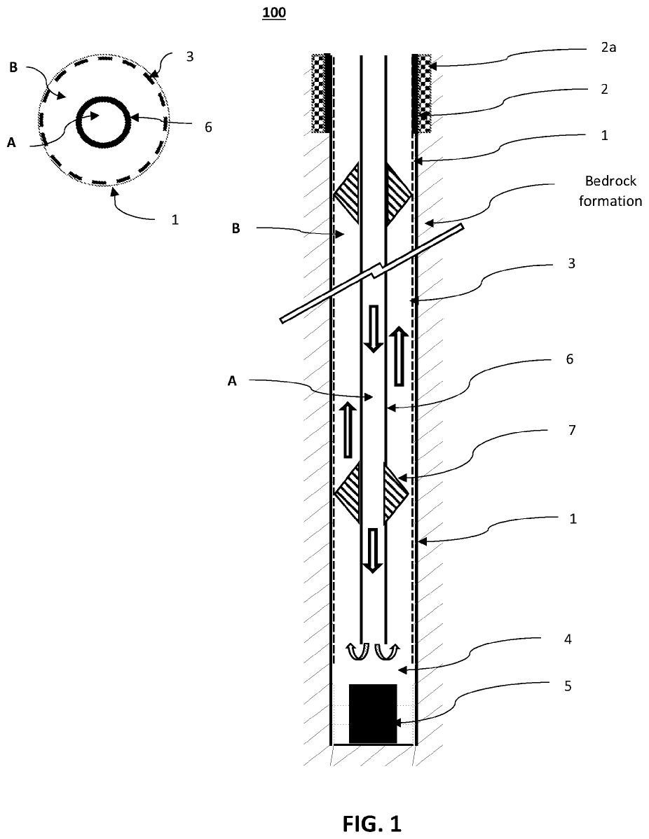

Referring now to FIG. 1, a heat exchange system 100 is illustrated according to some embodiments. In this example, FIG. 1 shows an axial view (top-down) and cross-sectional (side) view of one embodiment of an HVHF-CGHEX (e.g., using a flexible liner) installed within a drilled competent, bedrock borehole (1), which extends below a surface casing (2) that is set and grouted (2a) through shallow or unstable sediments. In embodiments, it may be shallow overburden and weathered bedrock. The depth of the surface casing (2) may be dependent, for instance, on geological conditions and local and state regulations.

While the HVHF-CGHEX of embodiments is capable of multi-directional flow, it is depicted with center flow down (A) in FIG. 1 and throughout this disclosure as indicated by the arrows. Flow could also be upward through (A) in embodiments. The design is also capable of variable, multi-directional heat flux. For the purposes of illustration in this disclosure, all figures and descriptions depict a cooling mode, where heat is transferred into the energy exchange fluid by one or more heat pumps. The leaving water temperature (LWT), defined as the temperature of the EEF leaving the heat pump(s), reflects elevated temperature from transferred heat being sent down into the HVHF-CGHEX (Channel A). Entering water temperature (EWT), defined as the temperature of the EEF returning to the heat pump(s), reflects EEF cooled while travelling through the HVHF-CGHEX and exchanging energy with the borehole wall and surrounding formation (Channel B). However, the systems described herein could also be operated in a heating mode according to embodiments.

With further reference to FIG. 1 and system 100, the large diameter outer tube (3) can be relatively thin, yet strong. According to embodiments, it is constructed of flexible materials. Materials may include, for example, PVC (e.g., having a wall thickness between 0.050″ and 0.250″). In some embodiments, smooth or soft PVC may be used in combination with a one or more plies of thread-like material wrap. In some embodiments, the wrap material may comprise polyester yarn or line oriented axially, left-spiral, and/or right-spiral to control the shape, the burst pressure, and elongation of the tube. In some examples, the tube may be a lay flat discharge hose, such as the VF Series hose provided by Kuriyama of America, Inc. In some instances, a material having an operating temperature in the range of −5 F to 170 F degrees may be used.

In the example of FIG. 1, a lower extent of tube (3) is folded and clamped (4) to seal the tube to form a closed cell and separate EEF from the borehole wall (1). In certain aspects, because of its pliability, the outer tube (3) inhibits groundwater movement within the borehole by conforming tightly to the borehole wall (1) after inflation. According to embodiments, water is used as the EEF, thus minimizing any impact to the environment should a leak occur. Further, and in some embodiments, all components in contact with the environment are either made of inert materials (e.g., stainless steel, HDPE, ceramic, etc.) or materials having minimal environmental impact.

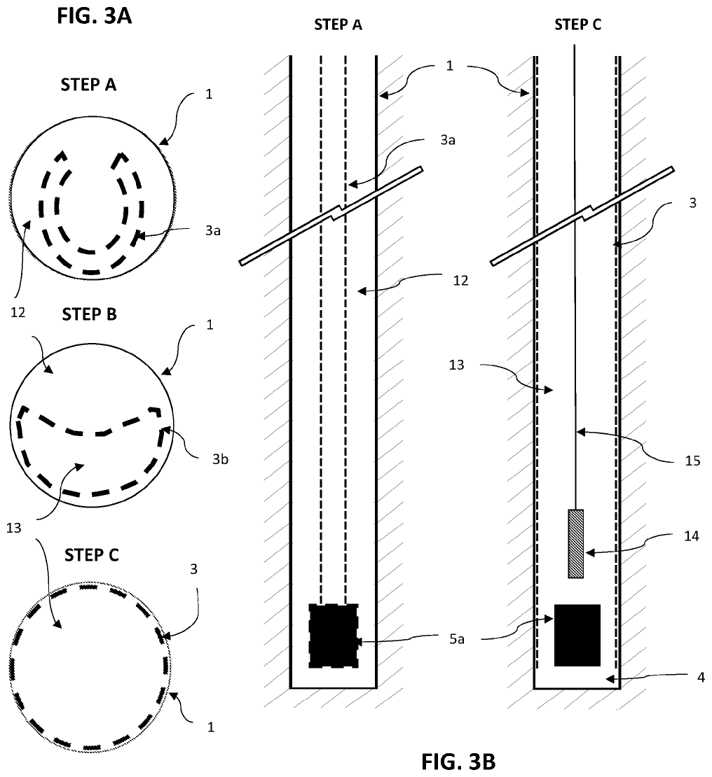

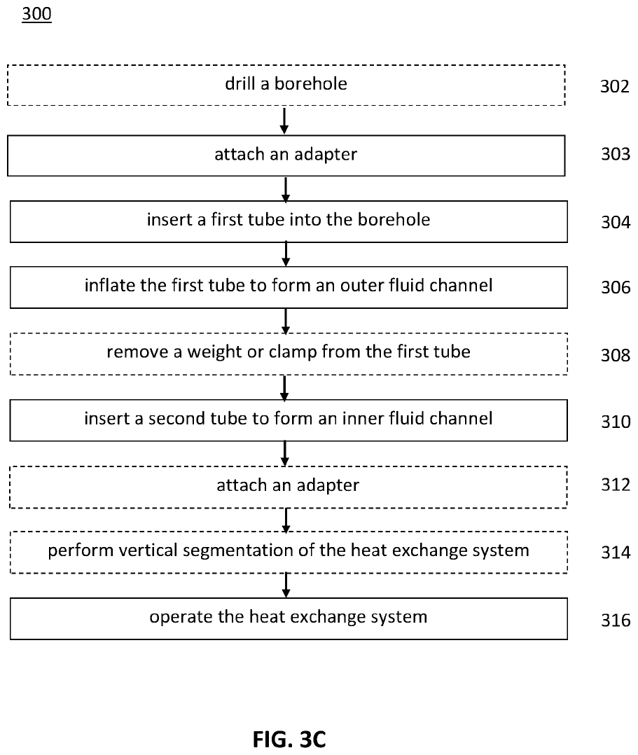

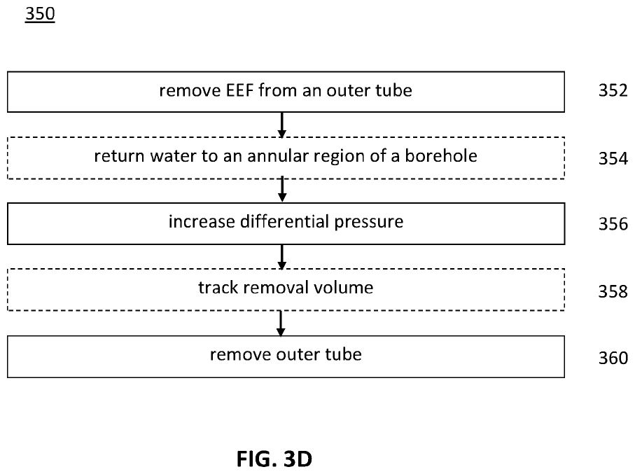

In some embodiments, weight may be required to overcome buoyancy when installing the dry outer tube (3). Two configurations of the weights may be used, for example: (i) an external weight (5) attached to the clamp (4), which hangs below in the borehole (1) as shown in FIG. 1; and (ii) a retrievable internal weight (Sa) is placed inside the outer tube (3) and then extracted after inflation. In the second example, the internal weight provides the advantage of less weight should the outer tube (3) need to be removed at any point, for instance, as described in connection with FIGS. 3A-3D.

In the example of FIG. 1, the inner tube (6) is centered within the outer tube (3) by a series of regularly spaced centralizers (7), which may incorporate a spiral shape to facilitate mixing of the moving EEF in annulus channel (B). According to embodiments, the inner tube (6), is constructed of PVC or other non-corrosive material. Other materials may be used. The diameter and thickness of the inner tube (6) can vary according to the size of the HVHF-CGHEX and governed by considerations of flow rates, pressure drops, and transit time for the EEF. In certain aspects, the ratio of an outer tube (3) to inner tube (6) diameter is important for heat transfer. The smaller diameter of an inner tube (6) causes EEF to travel faster through channel A, while the considerably smaller surface area of the cylinder wall of an inner tube (6) reduces heat conduction. Conversely, the large annular space (B) between an outer tube (3) and an inner pipe (6) slows the ascending flow rate providing longer residence time and contact with the larger surface area of an outer tube (3) enhancing heat exchange with a borehole wall (1). Example sizes for the inner tube (6) can range from 1.5″ to as large as 8″, with 2″ to 4″ as specific examples. Other sizes may be used according to embodiments.

Embodiments may provide a number of advantages. For example, a high volume, high flow ground heat exchanger can be installed to any depth, with an example range between 300 ft and 800 ft deep, and example diameters of 6″-9″. In certain aspects, embodiments may: comprise a large diameter outer tube (3) or casing (16) that stores a considerable volume of EEF in the subsurface; comprise a large diameter outer tube (3) or casing (16) with a large cylindrical surface in direct contact with the borehole wall, comprise a design with a minimal ratio of material thickness (tube, pipe, grout) of the outer tube (3) or casing (16) vs. radial distance to the borehole wall, and/or comprise a smaller diameter inner tube (6) centralized within the outer tube (3) or casing (16) to create two flow channels and having a smaller cylindrical surface for lower heat conduction between the two flow channels, where the diameter of the inner tube (6) is governed by considerations of flow rates, pressure drops, and transit time for the EEF.

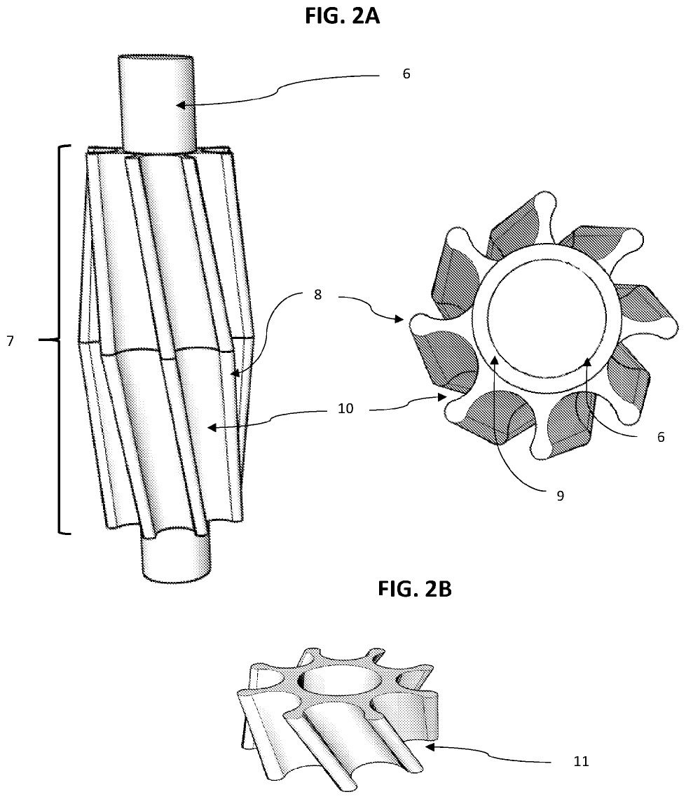

FIGS. 2A and 2B depict details of a centralizer (7) according to some embodiments, including isometric and axial views of centralizer (7) in FIG. 2A and an isometric view of turbulator (11) in FIG. 2B In these examples, a plurality of fins (8) are arranged about an axial element (9) whose interior diameter is sized to a center tube (6). The fins (8) are twisted about the z-axis to create a helix, while in some embodiments, the outside dimension of the fins (8) tapers to the distal end. Flow channels (10) allow the EEF to flow pass while imparting a swirling motion to facilitate mixing. According to embodiments, the axial length of a centralizer (7) can be increased by adding and stacking sections (11) between the two ends. Alternatively, a section (11) can be used alone as a turbulator to mix flow. The centralizer (7) and the components are made from molded rubber, injection-molded plastic, or by additive manufacturing, and can be made in a variety of sizes and configurations to fit various combinations of outer tube (3) or casings (16) and center tube (6) dimensions. Other materials can be used.

Embodiments may comprise centralizers (7) attached to the inner tube (6) at regular intervals to fit between outer tube/casing (3 or 16) and inner tube (6) to maintain concentricity in the annular area. The centralizers may, for example, be spiral fluted with a plurality of fins (8) arranged about a central core (9) and sized to the outside diameter of the inner pipe (6), and having the fins (8) twisted to form a helix where the flow channels (10) cause the EEF to spiral to facilitate mixing. Additionally, a turbulator section (11) may be used independently or included in the centralizer stack (7) to increase the overall axial length.

FIGS. 3A-3D depict processes according to some embodiments.

Referring now to FIGS. 3A and 3B, the evolution of an installation process using a retrievable internal weight is depicted, with a plan view shown in FIG. 3A and a side view shown in FIG. 3B. According to embodiments, an outer tube (3) is prepared for installation at the surface by fully inserting the retrievable inner weight (5a) into the lower end of the outer tube (3), which is then sealed by folding its bitter (or loose) end and clamping it with a bar clamp (4). The clamp may be made, for example, of stainless steel or other long-lasting material. In some instances, the weight (5a) may be necessary to counter the buoyant forces of the dry, empty outer tube (3).

According to embodiments, the dry outer tube (3) is installed by lowering the weighted end (4 & 5a) into a borehole (1). It is shaped into a collapsed condition by folding along its axial plane (3a) to provide clearance from a borehole wall (1) during its descent, as illustrated in Step A of FIGS. 3A and 3B. As installation progresses, the folded outer tube (3a) is temporarily restrained with breakaway bands or tape to maintain the reduced profile. A borehole (1) may or may not initially be full of water (12) however, displacement from a descending tube may cause water level (12) to rise. Upon reaching total depth, the clamp (4) or the external bottom weight (5) land and sit on the bottom of the borehole (1) to provide a solid foundation for the lower extent of the outer tube (3). A metered volume of EEF (13) is then added to the interior of the outer tube (3). That is, the tube is filled. As the EEF level rises (13) above the water level in a borehole (12), differential pressure starts to inflate an outer tube (3), as shown in Step B of FIG. 3A, causing it to unfold (3b) and finally fully conform (3) to a borehole wall (1), as illustrated in Step C of FIGS. 3A and 3B. According to embodiments, the outer tube (3) is designed with a burst pressure that greatly exceeds the differential pressure noted above. Additionally, the inner weight (5a) is then removed by lowering a wireline overshot (14) on a cable (15), latching to a receiver on the top of the weight (5a), and then retrieving the entire assembly (14 and 5a) by retracting the cable (15).

In some embodiments, an HVHF-CGHEX or other exchanger design and related processes can also be utilized in loose, unconsolidated formations by the installation of permanent casing. Additionally, for embodiments having an external weight (5) configuration, the bar clamp (4) is first attached to the bitter end of the outer tube (3) and then connected to the weight (5) The remaining steps are the same.

Referring now to FIG. 3C, a process 300 in a heat exchange system is provided according to embodiments. The process 300 may be used, for instance, in connection with the operation or installation of a heat exchange system as illustrated in one or more of FIG. 1, 4, 6, or 27. Additionally, steps of 300 may be used as described in connection with FIGS. 3A and 3B.

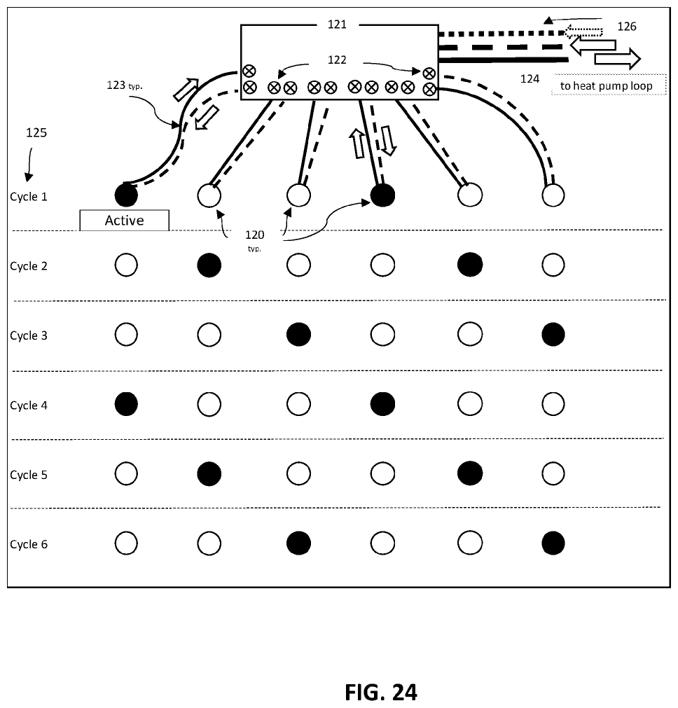

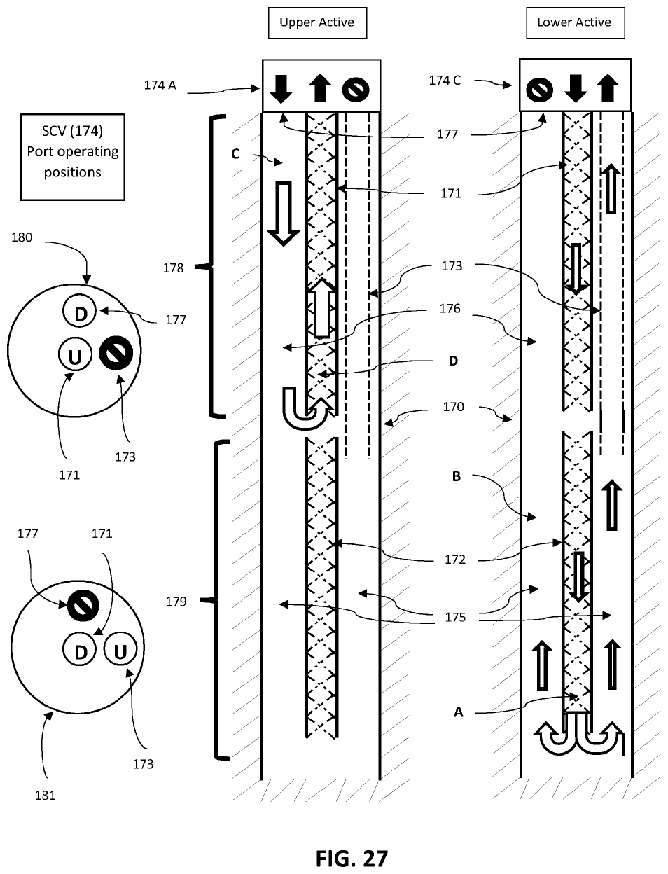

According to embodiments, the process may begin with step 302, in which a borehole is drilled. In steps 303 and/or 312, an adapter can be attached. In step 304, a first tube is inserted through the adapter and into the borehole. In step 306, the first tube is inflated to form an outer fluid channel. Where the tube has a removable weight or restraint, in step 308, the weight or restraint is removed. In step 310, a second tube is inserted to from an inner fluid channel. In step 314, one or more of the first and second tube may be vertically segmented, for instance, as described with respect to FIG. 27. In step 316, the system is operated. In some embodiments, operation 316 can include flowing an EEF, such as water, through the system (e.g., according to the processes described in connection with FIGS. 24, 25, 26A, and 26B). According to embodiments, at least steps 302, 308, 312, and 314 may be optional.

In some embodiments, the process 300 comprises a method for the installation of a flexible outer tube (3) within a bedrock or cased borehole. Embodiments use a bottom weight (e.g., 5 or 5a) to facilitate outer tube (3) installation by providing enough weight to overcome buoyancy of evacuated tube. In a first embodiment, a dedicated, permanent external weight (5) can be used in certain applications. In a second embodiment, a reusable, retrievable weight (5a) is inserted into the bottom of the outer tube (3) prior to sealing the lower extent. In some embodiments, the empty outer tube (3) is shaped into a collapsed profile by folding into a U-shape along the axial plane. Breakaway bands or tape may be attached periodically as the outer tube (3) is set to maintain both the U-shape (3a) and provide clearance in the borehole. Where inflation and expansion of the tube is achieved by filling with EEF, a differential pressure exceeding the borehole water level may be sufficient to break the bands/tape and permit the outer tube (3) to unfold, expand, and conform to the borehole wall as filling is completed. With process 300, handling of the outer tube (3) can be eased, and a simplified process increases the efficiency of installation, reduces the installation risk and enables GHEX to be installed or repaired in tight site locations.

In some embodiments, operation 316 of the system may comprise measuring and/or monitoring temperature, pressure, and flow or other parameters at each HVHF-CGHEX (or other GHEX equipped with an adapter, such as the ASUB2L described herein) to collect device-specific performance information. This may comprise, for example, one or more of:
(i) the use of temperature, pressure, flow sensors and others which may be temporarily installed in ports (e.g., 45-46) of an ASUB2L spool assembly (e.g., 23/67) to periodically monitor conditions and tune performance;
(ii) the use of one or more data loggers in addition the temporary sensors for periodic, continual measurement;
(iii) the option to equip each measuring port (e.g., 44, 45, and 46) with dedicated, real-time sensors installed with watertight compression fittings;
(iv) the ability to have multiple sensors share each access port through a connected tee arrangement (not shown);
(v) interfacing one or more sensors with a micro-controller or other device located within the ASUB2L for the purpose of monitoring and communicating data to a network for external data acquisition and management;
(vi) the use of a data/power cable to connect a controller or device to power and other network devices via protocols such as PoE, Cat 6, and/or low voltage power which may be connected to the conduit disconnect (e.g., 27) on the surface riser (e.g., 22); and/or
(vii) access through the center tube (e.g, 25) and lower access tube (e.g., 45) to allow the depth-specific temperature and other measurements in flow channels A and B along the entire length of the HVHF-CGHEX (or other GHEX equipped with an adapter according to embodiments).

Referring now to FIG. 3D, a process 350 for removal of an outer tube of a heat exchange system is provided, according to some embodiments. For instance, process 350 may be a method for the removal of a flexible outer tube within a bedrock or cased borehole, as described with respect to FIG. 1, 4, 6, or 27. The process may begin with step 352, in which a pump is used to remove FEF (e.g., water) from the interior of the outer tube (3). In step 354, which maybe optional in some embodiments, EEF (e.g., potable water) is returned to the borehole annular region (12) to replace the volume displaced as the outer tube (3) shrinks and collapses inward. In step 356, a differential pressure from exterior to interior on the outer tube (3) is increased to drive fluid out of the interior as the entire tube collapses axially while being emptied of fluid. In step 358 the removal is tracked, for example, using a flow meter to track the specific volume removed to determine when the outer tube (3) has been sufficiently emptied. In step 360, the outer tube (3) is removed. It may be removed, for example, by hoisting using equipment such as a crane, a hoist, a powered reel/spool, or other suitable means to remove the tube (3) once emptied.

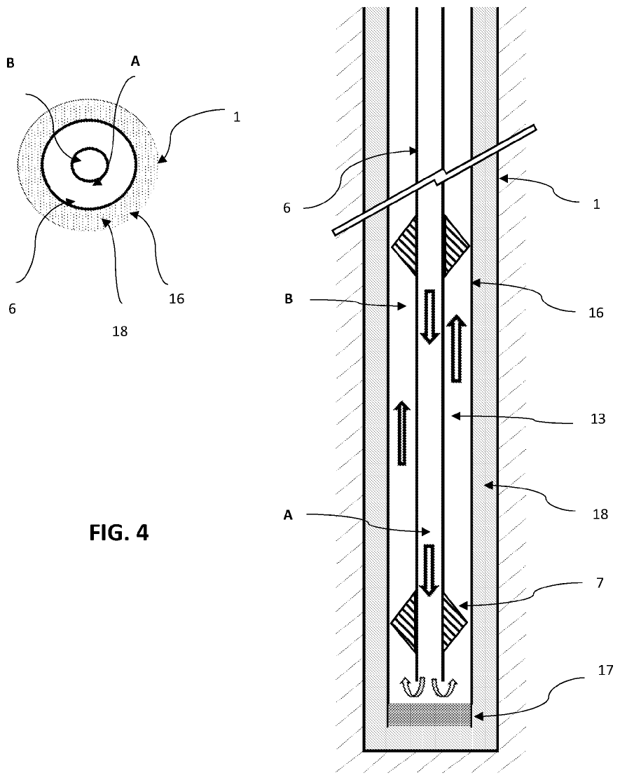

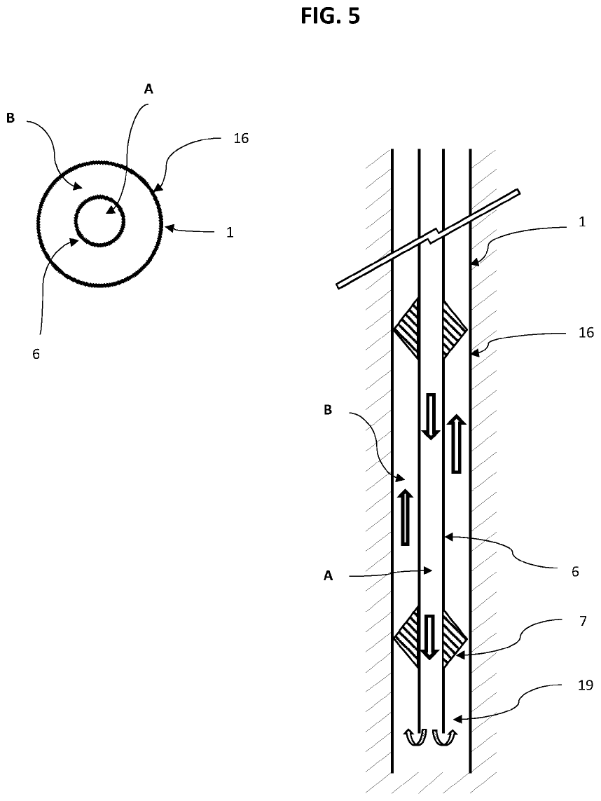

Additional configurations of an in-ground heat exchange system are illustrated with respect to FIGS. 4 and 5, according to some embodiments.

FIG. 4 illustrates axial and side cut-away views of an exchanger, such as an HVHF-CGHEX, constructed in an unconsolidated or loose formation utilizing a casing grouted inside of a large borehole, according to embodiments. In certain aspects, FIG. 4 depicts the installation of an outer casing (16) in a larger borehole (1) which is typically advanced and kept open using a variety of drilling methods best suited to the drilling conditions. A variety of materials such as HDPE, PVC, steel, stainless steel or others suited to the application may be used for the casing (16), which is further sealed by a cap or plug (17) at the bottom in this example. Buoyancy is managed during the installation process by adding water or other EEF (13) to the interior of the casing (16). Once landed, the annular area between the borehole (1) and the casing (16) is backfilled with grout (18). A variety of grout types and mixes are suitable, and in some embodiments, the grout will maximize thermal conductivity while conforming to state and local guidelines and regulations. According to embodiments, the installation of the inner tube (6) is the same as described for the bedrock design described with respect to FIG. 1.

In some embodiments, the HVHF-CGHEX is constructed in a casing (16) that is either driven, drilled, or advanced into, and establishes solid contact with, the formation. FIG. 5 depicts an example of this configuration according to embodiments, including axial and side cut-away views of a HVHF-CGHEX in loose, unconsolidated formation. Outer casing driven or advanced into formation creating direct contact with formation. Casing (16) with structural integrity, such as mild steel, stainless steel, or other alloys, is advanced and cleaned out during the process of drilling. Upon reaching total depth, a commercially available seal (19) which may consist of a Jaswell seal, a packer, or other mechanical sealing devices is lowered to the bottom of a casing (16), positioned, and activated to seal the lower end of a casing (16). According to embodiments, the installation of an inner tube (6) is the same as in the bedrock design described with respect to FIG. 1.

The large diameter of the HVHF-CGHEX outer tube (3) or casing (16) can provide a much greater surface area for heat conduction and stores a significant volume vs. U-tubes. Table A illustrates the comparison of certain proposed HVHF-CGHEX designs to a 1.25″ SDR11 U-tube of similar depth, where “0” indicates difference from base case of 1.25″ SDR 11. According to embodiments, the larger volumes of the HVHF-CGHEX can provide a more significant supply of temperate, pre-conditioned EEF to the heat pump(s) thereby increasing the COP for the GSHP.

TABLE A

| | Surface Area of Circumference | Volume |
|---|---|---|
| GHEX Type | (ft\hat{ }2/ft) | (ft\hat{ }3/ft) |
| 1.25″ SDR 11 | .320 (assumes 60% active | .012 (2 legs) |
| | conduction × 2 legs) | |
| HVHF-CGHEX - 5″ | 1.317 (4.1 X) | .107 (8.9 X) |
| HVHF-CGHEX - 6″ | 1.618 (5 X) | .197 (16.4 X) |
| HVHF-CGHEX - 8″ | 2.136 (6.67 X) | .348 (29 X) |

In another aspect, an adapter is described. For instance, an Accessible Subsurface Adaptor to Lateral Connections (ASUB2L) is provided according to embodiments.

In some embodiments, the ASUB2L consists of a two-piece unit that seals the HVHF-CGHEX (or other applicable GHEX) while providing full surface access to the GHEX internal, the borehole, and the laterals. This access may be, for example, throughout the design life without any surface disturbance. The two pieces may comprise an outer shell and an internal spool. In some embodiments, an ASUB2L over/under (ASUB2L-O/U) provides an over/under configuration with lateral connections (e.g., in the shell) placed above and below each other, having a standard orientation of these connections, generally oriented along the same azimuth. Other orientations are possible by customizing the relative rotation of the two chambers along the z-axis. For example, in some embodiments, an ASUB2L same elevation (ASUB2L-S/E) provides lateral connection in those instances where the laterals must be at the same elevation.

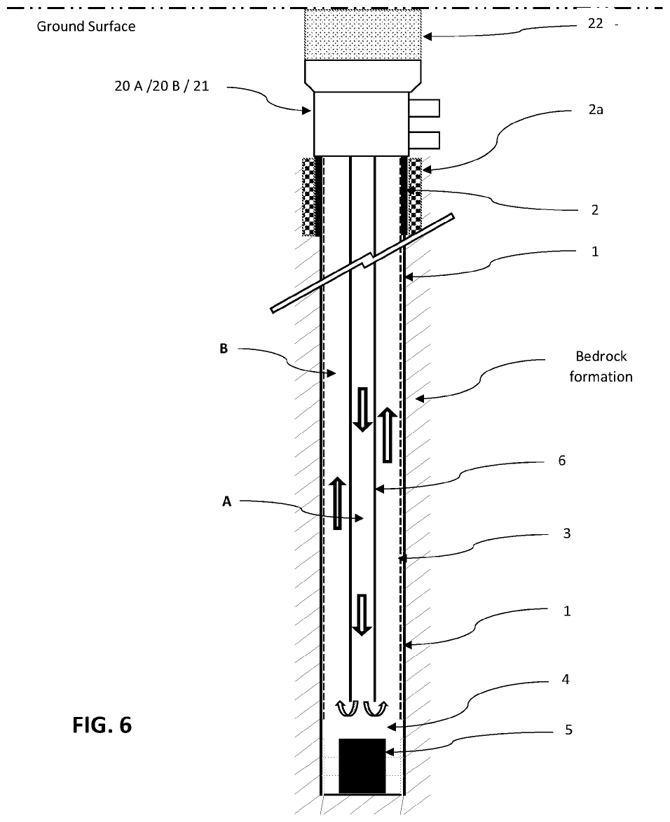

According to embodiments, the ASUB2L outer shell is installed to below frost depth and connects to the laterals and the borehole surface casing. Additionally, a short riser pipe can be used that extends to near surface where it can be capped with a 12″ cover or cover of other size, or a DOT-rated manhole for high-traffic locations to provide easy access to the sub-surface components. For competent bedrock installations, an internal adaptor mates to the top of the flexible outer tube and makes a water-tight seal between the ASUB2L's outer shell and the outer tube, for instance, as described in connection with FIGS. 1 and 6.

The ASUB2L described herein may provide certain operations benefits. For instance, the process of flushing and purging laterals is simplified and improved utilizing a flushing spool that creates an immediate surface connection between the entering and leaving laterals, eliminating dirty flow through the HVHF-CGHEX (or any other designs where the ASUB2L is used). There are multiple embodiments of the internal, triple-disc spool assembly of the ASUB2L, which directs EEF between the vertical channels of the GHEX and the lateral lines. Connections to the laterals are made/broken as the spool assembly is either installed or removed from the surface. Removable internal components of the GHEX are attached to the lower side of the spool and can be easily accessed. The spool assembly is also equipped with measurement/access ports. They may be equipped with sensors and monitoring units. The ability to measure parameters at individual boreholes is a feature that enables leak detection, and the ability to assess the performance and tune the thermal exchange is also provided. In some embodiments, a lateral access spool enables surface access to each lateral to permit a small inspection camera, or a pressure test packer access to diagnose any potential problems in a lateral. According to some embodiments, such as those where the laterals are connected with home runs or arranged in a branch configuration, all of the laterals can be inspected, and any problem specifically located and remediated.

Thus, the ASUB2L according to certain embodiments preserves optionality should site conditions and/or thermal loads change with time. It can preserve clear, unimpeded access to the borehole so that a borehole could be drilled deeper should the site require additional borehole length due to changes the site layout or increased thermal loads.

Referring now to FIG. 6, an adapter mounted on a concentric ground heat exchanger (CGX) is illustrated according to some embodiments. In this example, an Accessible Subsurface Adaptor (ASUB2L) (20A/20B/21) is located below ground and connected to the top of the surface casing (2) of a drilled borehole. The ASUB2L could occupy the same position relative to the casing (2 or 16) as in FIGS. 1, 4, and 5 according to some embodiments. As shown in FIG. 6, a surface riser (22) is attached to the top of an outer shell (20A/20B/21), extending to the near surface where a cap (not shown) or a DOT rated manhole (not shown) complete the installation after back-fill. While compatible with the HVHF-CGHEX described herein, the ASUB2L is universal and can be utilized on other GHEX designs. In some aspects, surface riser (22) comprises a power or data telemetry conduit, and may provide unimpeded access to the borehole and exchanger in some embodiments.

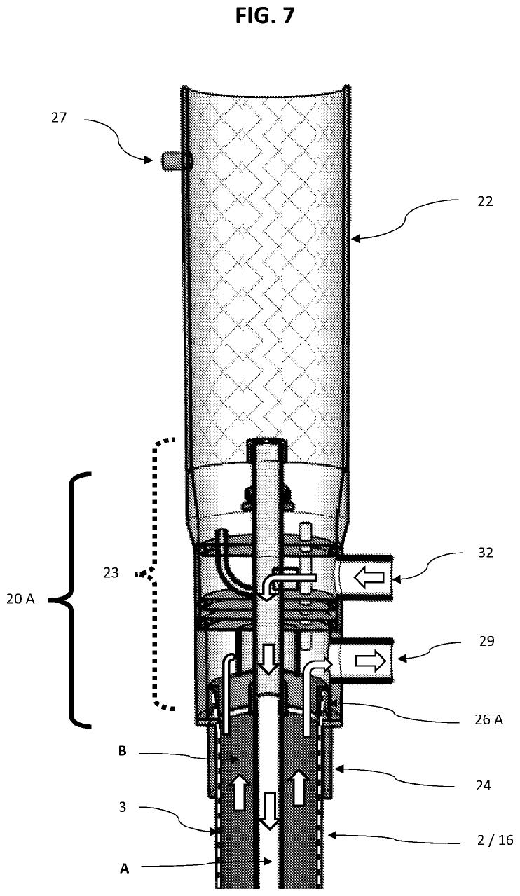

Referring now to FIG. 7, details of an adapter having an over-under configuration according to some embodiments are shown, with a cut-away view of the components of an ASUB2L-O/U. In certain aspects, the ASUB2L-O/U used in the example of FIG. 7 can be installed and attached to the top of a surface casing (2) of a drilled borehole (1), as described with respect to FIG. 1. It can also be directly connected to permanent casings (16) in unconsolidated situations, such as shown in FIGS. 4 and 5. According to embodiments, the design supports multi-direction flow, but for the purposes of this description and maintaining consistency with prior drawings, flow is shown entering and descending through the center channel (A) and returning upward via the annular flow channel (B). In this example, the ASUB2L-O/J outer shell (20A) contains a minimum of two connections to lateral piping (29, 32) and a water-tight connection (24) to a surface casing (2/16). As shown in FIG. 7, lateral piping connections are made to ports (29, 32). An appropriate length of commercially available PVC (or other material) is used as a surface riser (22) and is attached to the top of the outer shell (20A), extending to the near surface where a cap (not shown) or a DOT rated manhole (not shown) complete the installation after back-fill. Further, and in some embodiments, a power/data telemetry conduit can be connected to a surface riser through a drilled-through connection (27). The design shown is for a bedrock HVHF-CGHEX installation, where the outer tube (3) is installed in the borehole and sealed to the outer shell (20A) by means of the GHEX outer adaptor (26A), which can be provided in several diameters and connection styles. An internal spool assembly (23) directs flow between the vertical flow paths (A and B) and the lateral connections (29, 32).

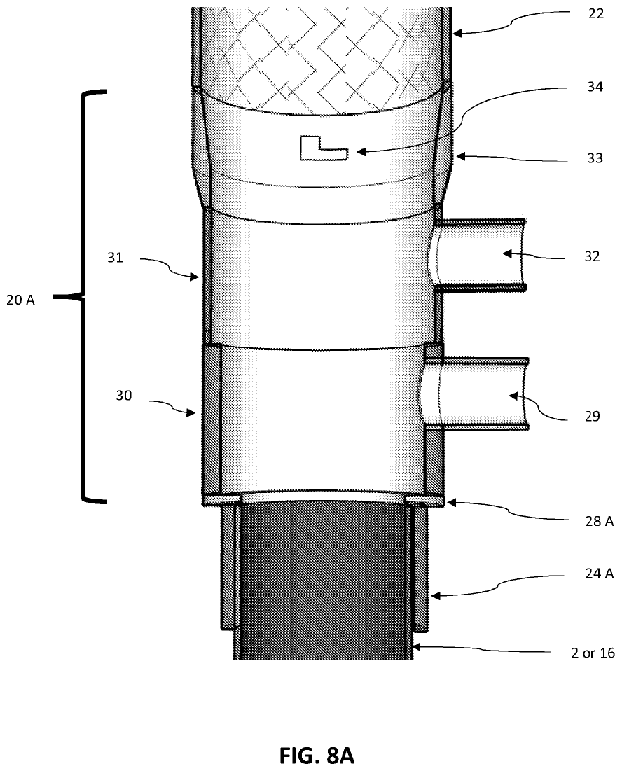

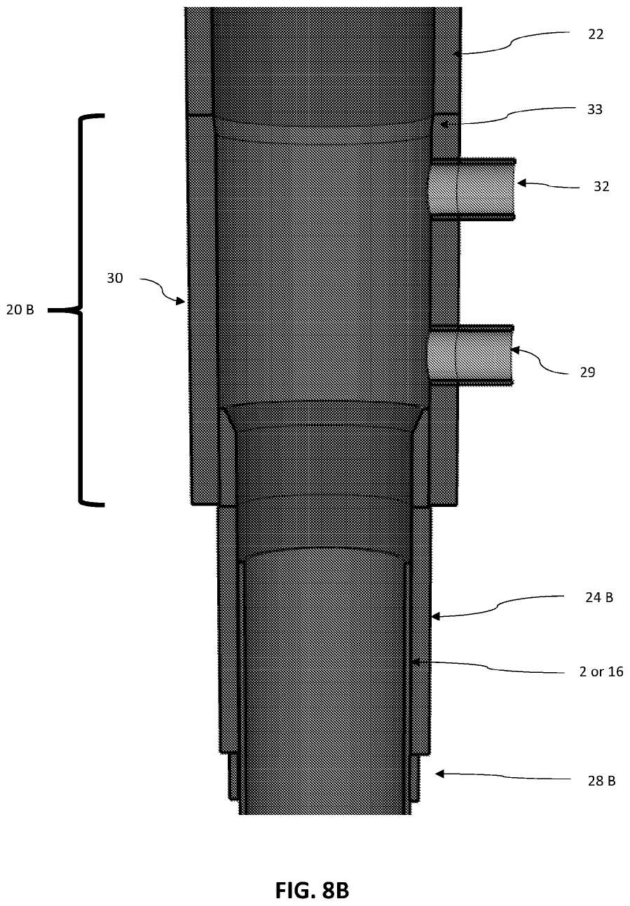

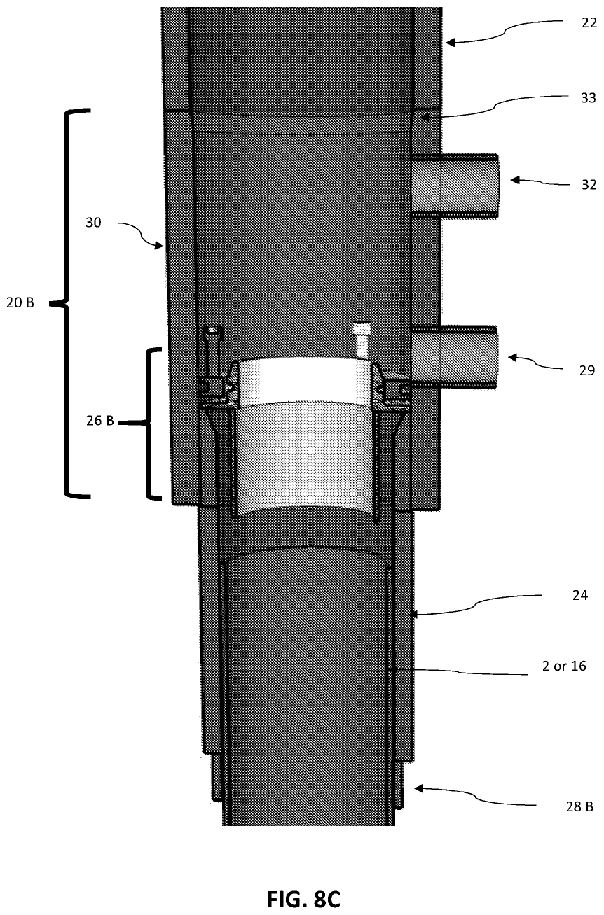

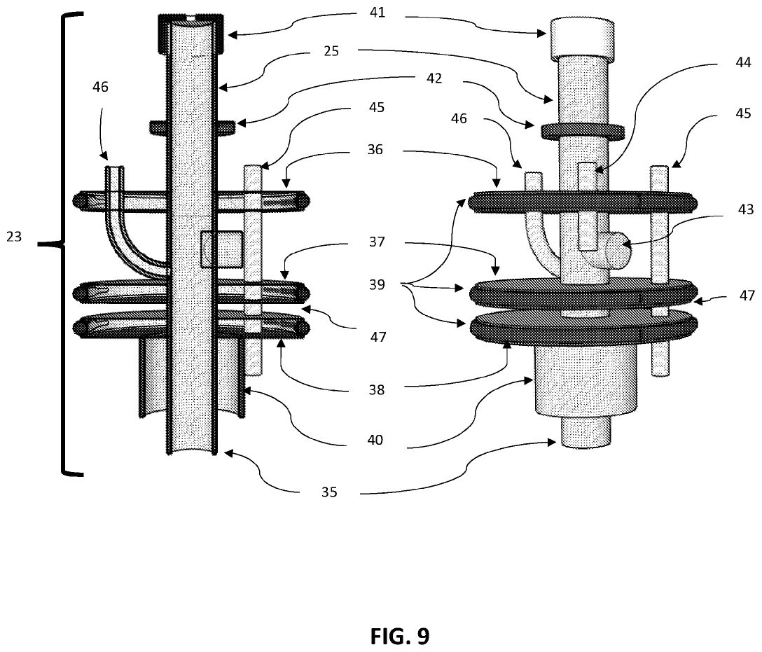

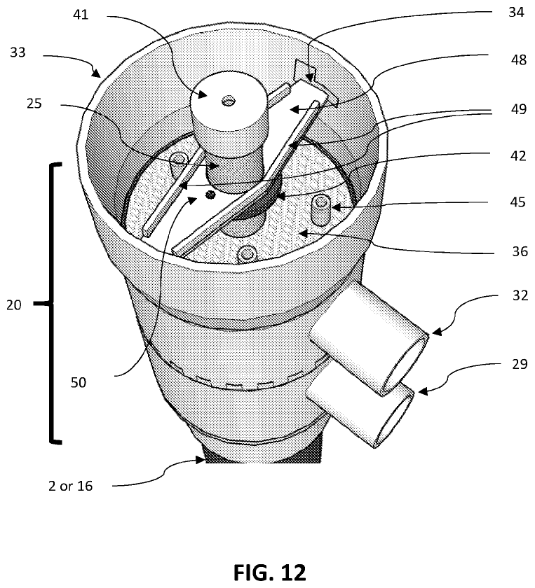

Referring now to FIG. 8A, a cut-away view is provided for an adapter (e.g., an ASUB2L-O/U) outer shell configured for O/U connections to lateral piping according to embodiments. In this example, the outer shell (20A) is attached to the casing (2 or 16) with a casing adaptor (24A) connected to the bottom landing plate (28A) with flexible sealant material (not shown) injected to the interior of a casing adaptor (24A) to make a water-tight connection between the interior of a casing adaptor (24A) and a casing (2 or 16) Casing adaptors (24A) can be provided in a variety of diameters to adapt to common well casings. The outer shell (20A) can be fabricated, for instance from corrosion-resistant materials and designed to be installed below the frost line. In this example, the landing plate (28A) is designed to sit atop a casing (2 or 16), transmitting the bearing load from an outer shell (20A) to a borehole casing (2 or 16). In this embodiment, the lower flow chamber (30) is slightly smaller diameter than the upper flow chamber (31) providing a landing lip to support a spool assembly (23), for instance, as shown in FIGS. 7, 9, and 10. In some embodiments, both flow chambers are ported with 3″ connections (29, 32) to lateral piping. Other sizes may be used. In this example, they are generally oriented along the same azimuth. Other orientations are possible by customizing the relative rotation of the two flow chambers (30, 31) along the z-axis. The outer shell upper section (33) provides the transition to the surface riser (22) and has a tapered internal surface to guide the O-rings (39) into position, for instance, as shown in FIG. 9. In some embodiments, two recessed J-slots (34) are milled into the interior to accept the ends of a hold down bar (48) (See FIG. 12) to keep a spool (23) locked in placed during operation.

Referring now to FIGS. 8B and 8C, cut-away views are provided for an adapter (e.g., ASUB2L-O/U) outer shell configured for O/U connections to lateral piping according to embodiments. In this example, the outer shell (20B) is attached to the casing (2 or 16) with a casing adaptor (24B) and flexible sealant material (not shown) injected to the interior of a casing adaptor (24B) to make a water-tight connection between the interior of a casing adaptor (24B) and a casing (2 or 16). Casing adaptors (24B) can be provided in a variety of diameters to adapt to common well casings. The outer shell (20B) can be fabricated, for instance, from corrosion-resistant materials and designed to be installed below the frost line. The landing ring (28B) is designed to attach to a casing (2 or 16), transmitting the bearing load from an outer shell (20B) to a borehole casing (2 or 16). In this embodiment, the flow chamber (30) is of uniform diameter. However, other designs may be used. The upper terminus of the casing adaptor (24B) provides a landing lip to support both the hose adaptor (26B) and a spool assembly (23), for instance, as shown in FIGS. 7, 9, and 10. In some embodiments, both flow chambers are ported with 3″ connections (29, 32) to lateral piping. Other sizes may be used. In this example, they are generally oriented along the same azimuth. Other orientations are possible by customizing the relative rotation of the two connections (29, 32) along the z-axis. The upper terminus of the outer shell assembly (20B) provides connection to the surface riser (22) and has a tapered internal surface transition (33) to guide the O-rings (39) into position.

FIG. 9 shows additional details (e.g., in cut-away and solid views) of an adapter spool assembly (23), such as for an ASUB2L-O/U, which directs flow between the vertical flow paths and the horizontal lateral connections according to embodiments. In this example, a center tube (25) is shown that has three separating discs (36, 37, 38) attached to the center tube (25), for instance, by welding, fusion, or molding. According to embodiments, all discs are outfitted with O-rings (39) along the outer circumference to seal against the interior wall of the upper chamber (31). The discs (36, 37, 38) can be made from steel, stainless steel, or thermally non-conductive materials such as HDPE, injection plastic, or ceramic. A coupling (40), concentric to the center tube (25), is attached to the bottom side of the lower disk (38) to provide connection to very large versions of an inner tube (6), such as showing with respect to FIGS. 1 and 4-7 for example. The side port (43) on the center tube (25) enables fluid to flow between port (32) and through the interior of the center tube (25) to the CT connection point (35), for example, as illustrated with respect to FIGS. 7 and 8. The side port (43) may be outfitted with a selected orifice (not shown) to enable flow control/measurement using differential pressure. In some embodiments, an intermediate disc (37) creates an air gap (47) to reduce the amount of heat conducted between the two flow channels. An installed inner tube (6) (not shown in this figure) can be attached using the CT connection (35). In some embodiments, an action ring (42) is located on the center tube (25) above the upper disc (36) and is used to install, remove, and hold in place the spool assembly (23). A retrieval and setting tool can latch on to the action ring (42), providing solid connection and control.

According to embodiments, the adapter configuration allows for sensing temperatures, pressures, and flow at a HVHF-CGHEX (or any GHEX). For example, measuring ports (44, 45, 46) access EEF flow at various points on the adaptor (23) Port 44 accesses the uppermost flow channel to measure the descending flow, referred to as Leaving Water Temperature (LWT). Port 45 accesses the lowermost flow channel to measure the returning/ascending flow, referred to as Entering Water Temperature (ETW). Port 46 measures inside the center tube (25). There are a multitude of ways these ports may be used depending upon the sophistication and data requirements of a GeoEE System. In one embodiment, they may be capped with fittings to enable quick connection for periodic manual measurement and adjustment. In another embodiment, temperature and/or pressure sensors can be installed in the ports and attached to a data logger for more in-depth measurement. In another embodiment, each measuring port (44, 45 and 46) may be equipped with real-time sensors installed with watertight compression fittings. Multiple sensors may also share each access port through a connected tee arrangement or similar setup. These sensors may interface with a micro-controller or other device situated above the upper disc (36). A data/power cable may be connected to the conduit disconnect (27) on the surface riser (22). Both the center tube (25) and lower sensor tube (45) allow access depth-specific temperature and other measurements in the respective flow channels A and B along the entire GHEX, in some embodiments. As shown in FIG. 9, the top of the center tube (25) can be sealed with either a cap (41) or a plug to permit sensor access and, may also include a purge valve (not shown) to release trapped air and eliminate air blocks in the device while filling the system with EEF.

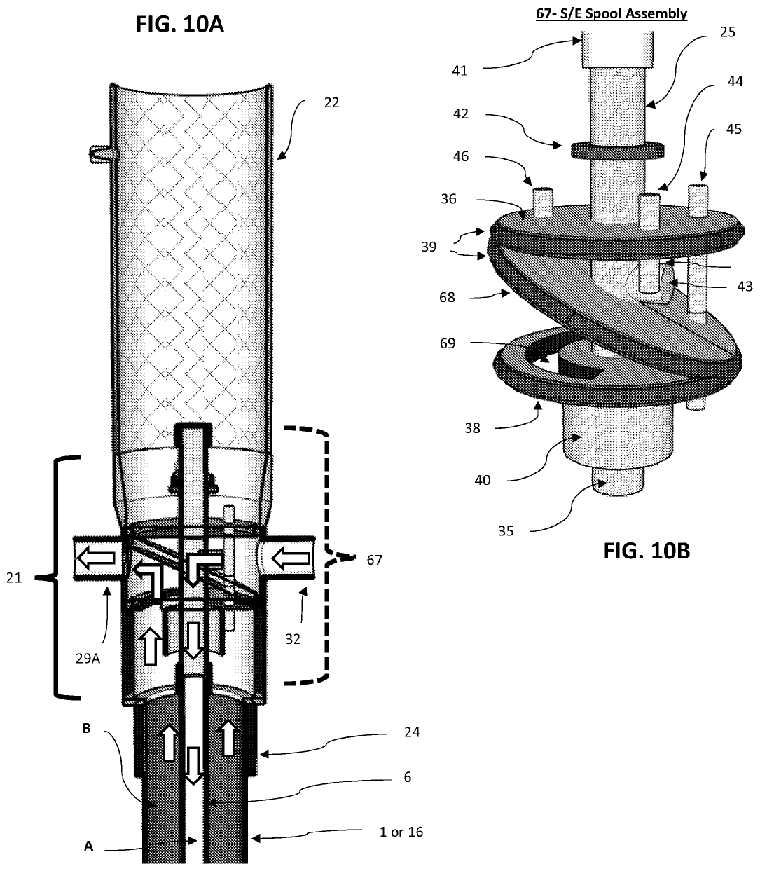

Referring now to FIG. 10, a subsurface adapter according to embodiments is shown. FIG. 10A is a cut-away view, while FIG. 10B is an isometric view (e.g., or an ASUB2L-S/E). In this example, the adapter is configured for lateral connection at the same elevation. In certain aspects, the relevant description of the over-under configuration described with respect to FIGS. 7-9 is incorporated here, where applicable. For example, and according to some embodiments, the CT tube connections (35 and 40), the action ring (42), the side port (43) and the sensor and equipment connections (41, 44-46) function as previously described.

While similar in form and function in certain aspects to the over-under device previously described, the ASUB2L-S/E model shown in FIGS. 10A and 10B has three primary differences. First, the lateral connection points (29A and 32) are now at the same elevation on outer shell (21) and are diametrically opposed to each other. Other orientations of the lateral connection are possible by customizing the relative location of the annular (B) flow port (29A). Second, the flow separating disc (68) on the tube (25) forms a tilted ellipse angled within the cylinder of the outer shell (21) to separate the flow channels (A & B). While still directing flow, discs 36 and 38 also centralize and stabilize the S/E spool assembly (67) within the outer shell (21). Third, the lower disc (38) has a window (69) to allow flow from channel B to enter the ASUB2L, deflect off disc (68) and be directed to exit through port (29A)

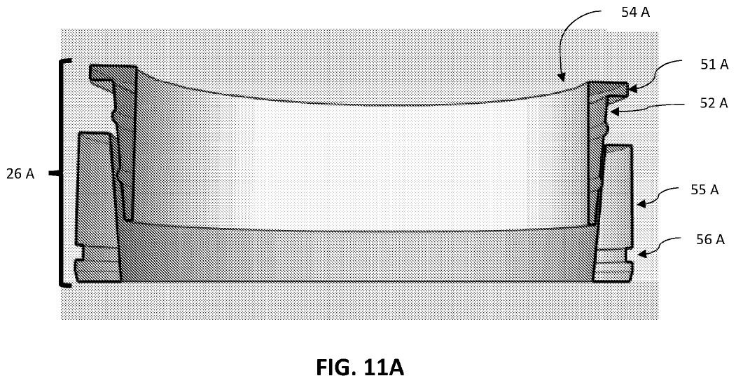

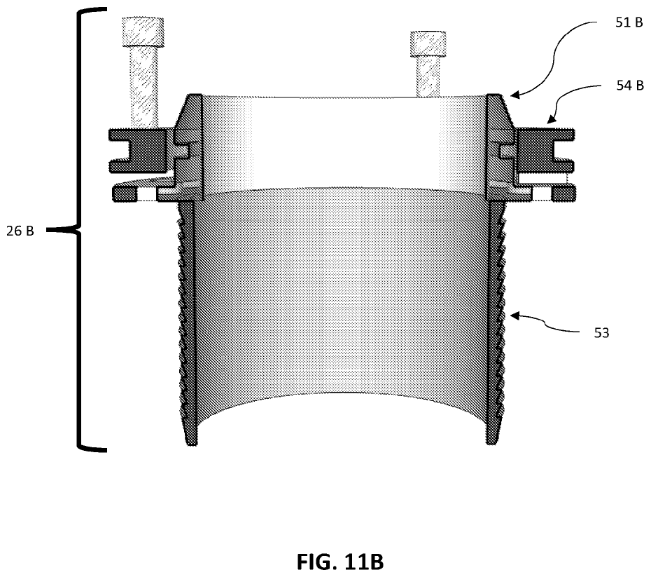

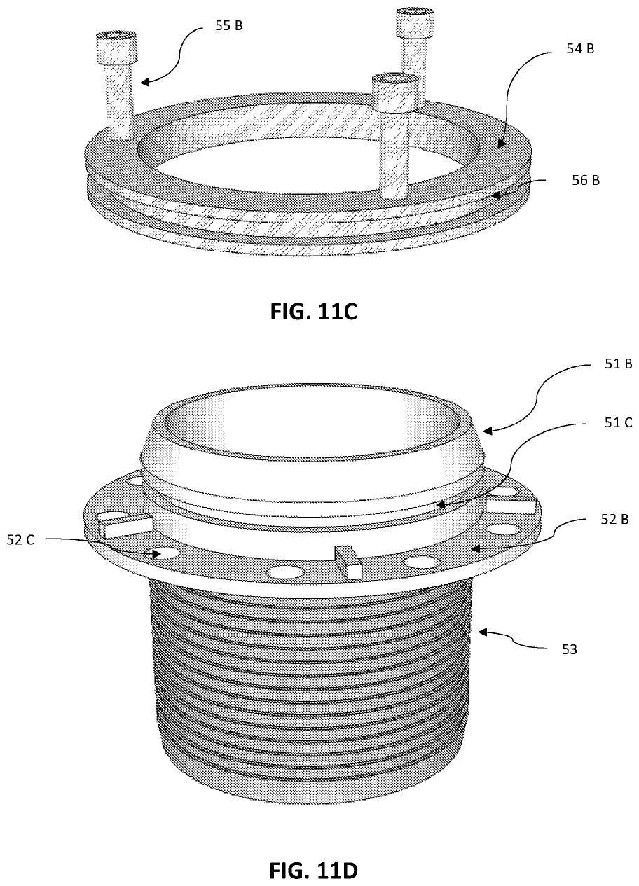

FIG. 11A, is a cut away illustration is showing an example of an ASUB2L tube adaptor (26A) designed for use with the flexible outer tube (3) according to some embodiments. The two-piece tapered split ring secures and seals the flexible outer tube (3). The connection is made by: (a) separating the two rings (52A and 55A), (b) pulling the outer tube (3) up through the interior of the lower half (55A), (c) positioning the end of the outer tube up over the tapered face of the upper/inner ring (52A) to make contact with the flange (51A), and (d) compressing the tube between the tapered faces, where the two pieces (52A and 55A) are brought together by bolts at location (54A) on the top of the inner ring flange (51A). The outer adaptor (26A) is designed to sit on top of landing ring (28A) and is sealed by an O-ring (56A) fit into the outer shell (20A/21). In some embodiments, the adaptor may contain bleed holes in the body of the lower ring (55A) to allow annular fluid between the borehole wall (1) and the outer tube (3) to be removed or added during the process of either inflating or collapsing the outer tube (3). Different configurations of the adaptor (26A) are envisioned to conform to a variety of GHEX diameters and types.

FIG. 11B is a cut away illustration showing another example of an ASUB2L tube adaptor (26B) designed for use with the flexible outer tube (3) according to some embodiments. The two-piece assembly is comprised of a flanged barb fitting (53) and a sealing ring (54B) to secure and seal the flexible outer tube (3). In some embodiments, different configurations of the adaptor (26B) are possible to conform to a variety of GHEX diameters and types.

FIGS. 11C and 11D illustrate aspects of an adapter according to embodiments. They may correspond, for instance, to the example 2-piece ASUB2L tube adaptor (26B) described in connection with FIG. 11B. According to embodiments, the connection is made by: (a) pulling the outer tube (3) up over the barbed outside diameter (53), and (b) securing the tube (3) using band clamps. In this example, the ASUB2L tube adaptor (26B) is designed to sit on the top edge of the casing adaptor (24B) and contains bleed holes (52C) in the ring flange (52B) to allow annular fluid between the borehole wall (1) and the outer tube (3) to be removed or added during the process of either inflating or collapsing the outer tube (3). In some embodiments, a top-side hub (51B) is used for installation and retrieval of both the ASUB2L tube adaptor (26B) and the attached outer tube (3), and for the segregation of annular fluid (between the borehole wall (1) and the outer tube (3)) from fluid within the outer tube (3) during the process of either inflating or collapsing the outer tube (3). A temporary separating standpipe can engage the center hub (51B) and seals with O-ring (51C) to manage the separated fluid levels. The sealing ring (54B) seals the ASUB2L tube adaptor (26B) during operation, as shown for instance with respect to FIG. 8C, to the outer shell (20B) using O-rings (51C, 56B). Three bolts (55B) in the sealing ring (54B) provide spacing and support for the lower disc (39) on the ASUB2L center spool assembly (23), for instance as configured with respect to FIG. 9. Different numbers of bolts may be used. In some embodiments, different configurations of the adaptor (26B) are possible to conform to a variety of GHEX diameters and types.

According to some embodiments, a series of casing adaptors (24A/24B) accommodate a variety of borehole diameters/casing sizes to connect the surface casing of any borehole to the ASUB2L outer shell (20A/20B/21). Likewise, a series of adaptors (26A/26B) can accommodate various sizes and types of outer tubes (3) to make a water-tight connection between an outer tube (3) of a GHEX and the outer shell (20A/20B/21) of the ASUB2L. Each adaptor (26A/26B) may contain sealable ports to allow fluid access from the annular region between borehole and the outer shell during installation or removal of the outer shell (3), comprised of two parts containing complimentary surfaces that when brought together, secure, compress and seal the upper extremity of the outer tube (3). In certain aspect, the adaptor can be installed or removed from the surface with an installation or lifting tool controlled from above ground.

FIG. 12 shows an isometric view of an ASUB2L spool assembly (23) in position within the ASUB2L-O/U outer shell (20) and held in place with locking bar (48) according to embodiments. In this example, a spool assembly (23) is anchored in the outer shell (20) with a locking bar (48), which slips over a center tube (25). Two diametrically opposed J-slots (34) in the outer shell (20) receive the ends of a locking bar (48), which seat in a locked position (e.g, with a slight clockwise turn). The two bolts (50) hold the spool assembly in place when tightened against the top of the action ring (42). In certain aspects, the locking function is the same for both over-under and same-elevation adapters.

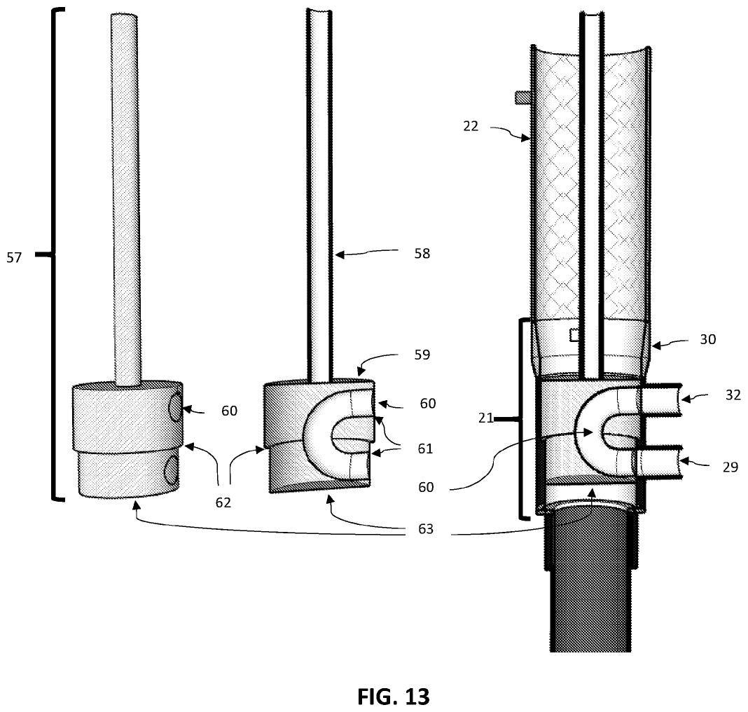

FIG. 13 provides solid and cut away views of a lateral flushing spool (57) that may be used, for instance, with over-under embodiments. In this example, a cylinder (59) with stepped diameters is shown, with a lower portion of the cylinder fitting inside the outer shell of lower chamber (30) and having its shoulder (62) rest on the lip in the lower outer shell (30) to index and align the internal u-shaped passage (60) with the lateral connections (29 and 32) while the lower face (63) blocks downward flow to the GHEX. According to embodiments, O-rings (61) on the face of the flushing spool (59) can provide a water-tight connection between the spool (59) and the lateral connections (29 and 32). As shown in FIG. 13, the spool provides a direct flow path between the two laterals (29 and 32). A flushing fluid enters through one lateral (29), and then exits the other lateral (32) carrying any dirt or debris back to the flushing station and avoiding any contamination to the vertical exchanger. Flow can be in either direction through the flushing spool (59). The stem (58) is used to lower flushing spool (59) into position, and also enables retrieval from the surface.

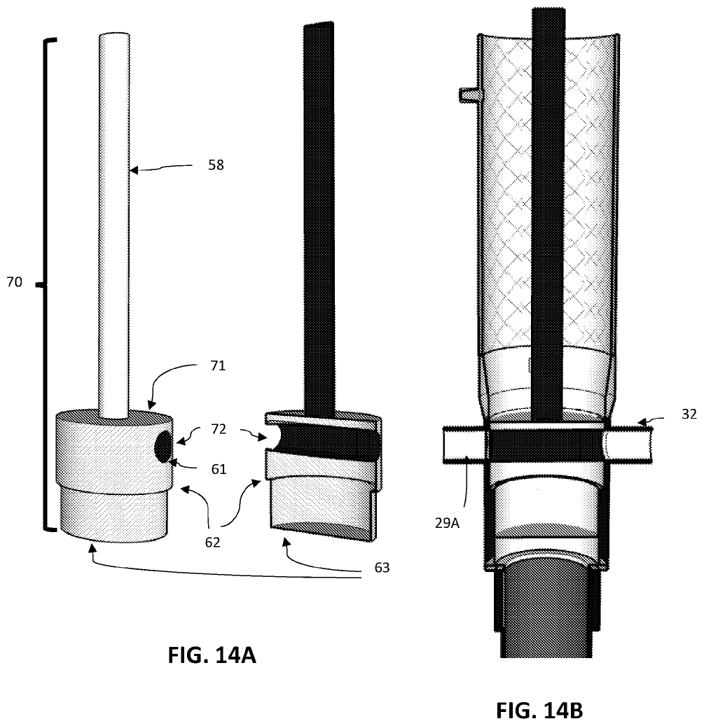

FIG. 14A provides solid and cut away views of a lateral flushing spool (70), which may be used with a same-elevation adapter according to embodiments and as illustrated in FIG. 14B. In this example, a solid cylinder (71) with stepped diameters is used, with a lower portion of the cylinder fitting inside the outer shell lower chamber (30) and having its shoulder (62) rest on the lip in the lower outer shell (30) to index and align the internal straight passage (72) with the lateral connections (29A and 32) while the lower face (63) blocks downward flow to the GHEX. According to embodiments, O-rings (61) on the face of the flushing spool (71) can be used to provide a water-tight connection between the spool (71) and the lateral connections (29A and 32). The spool provides a direct flow path between the two laterals (29A and 32). A flushing fluid enters through one lateral (29A), and then exits the other lateral (32) carrying any dirt or debris back to the flushing station and avoiding any contamination to the vertical exchanger. Flow can be in either direction through the flushing spool (71). The stem (58) is used to lower flushing spool (71) into position, and also enables retrieval from the surface.

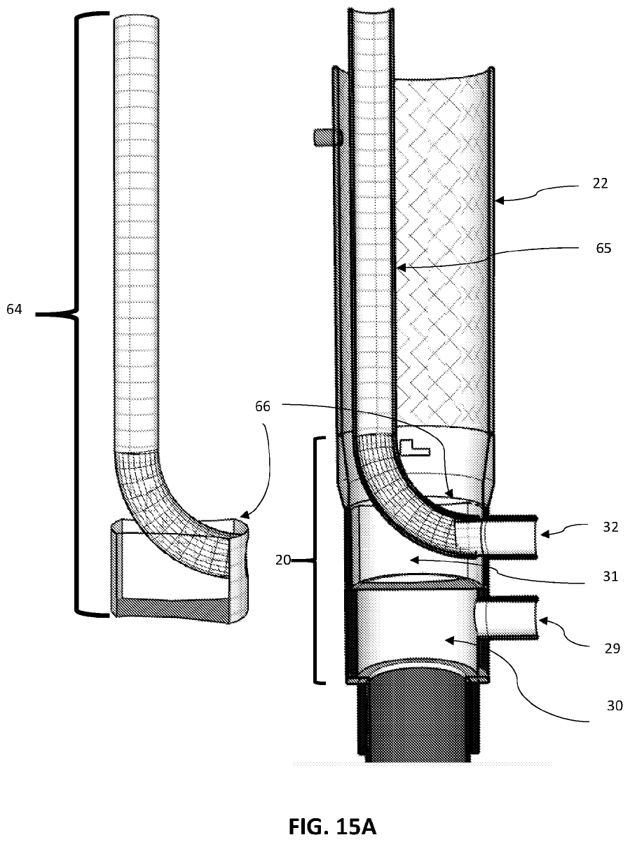

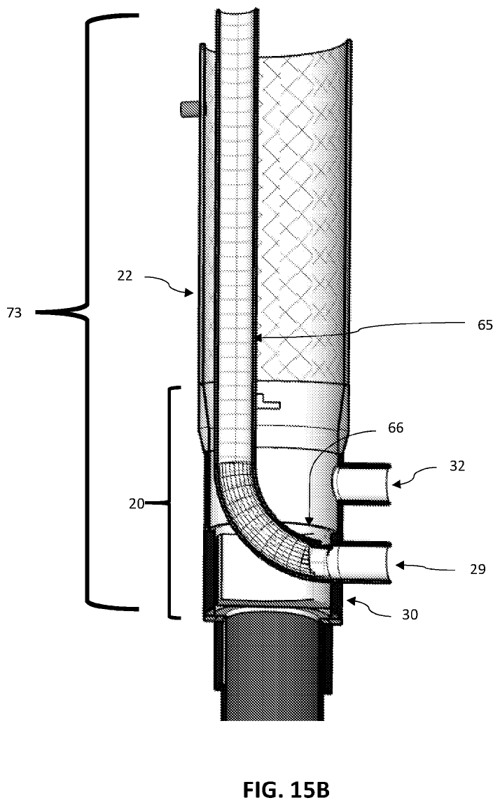

Two examples of a lateral access tool are shown in FIGS. 15A and 15B according to embodiments. These tools are designed to allow an inspection camera, leak detection equipment, or a variety of diagnostic tools to access a lateral without any excavation to identify and/or pinpoint a leak or other issues in a lateral. FIG. 15A is a cut-away view of an upper lateral access tool (64) providing surface access to the inside of the upper lateral (32). This embodiment may be used, for example, with an over-under style adapter. Here, the off-set tube and sweep from vertical to horizontal (65) are positioned in a spool (66) that conforms to an upper chamber (31) of an outer shell (20/21) and rests on the top lip of the lower flow channel (30) to provide an access path from the surface. FIG. 15B is a cut-away view of a lower lateral access tool (73) providing surface access to the inside of the lower lateral (29). The off-set tube and sweep from vertical to horizontal (65) are positioned in a spool (66) that conforms to an outer shell (20) and rests on the top lip of the lower flow channel (30) to provide an access path from the surface. While the lower access lateral tool (73) is similar, it does have a smaller spool and a longer stem (65).

In certain aspects, adapters provided according to embodiments, in any configuration, preserves optionality should site conditions and/or thermal loads change with time by preserving clear, un-impeded access to a borehole to perform tasks such as drilling deeper, borehole modification, system modernization, or repair should the site require. An extension piece, equipped with an adaptor, such as part 55A as shown in FIG. 11A, channels drill cuttings, produced air, water, etc. to the surface while protecting the interior portions of the ASUB2L or other adapter from exposure.

Benefits of one or more embodiments may include:
(i) The ability to flush both laterals from within the ASUB2L, keeping any dirt and/or debris from infiltrating the vertical infrastructure of the HVHF-CGHEX (or GHEX) and being transported throughout the depth. Multiple models of flushing spool can accommodate different ASUB2L models. In embodiments, the flushing spool (57/70) is installed and positioned from the surface. Embodiments may not require any excavation.
(ii) The capability of bi-directional flow to facilitate a flushing program. This could include the means to enable access from the surface to the interior of connected laterals at each ASUB2L to identify and evaluate the specific location of potential leaks or other problems in lateral piping, thereby enabling minimal excavation targeted to the precise location for any potential repairs. Embodiments comprise two lateral adaptors, each specifically sized to fit the interior dimension of the outer shell (20/21) corresponding to the port.
(iii) Embodiments that offer means to access in-hole components throughout the entire life cycle supporting the implementation of solutions to resolve performance issues, leaks, etc. and execute maintenance, improvements and/or modernization. Examples include the use of a down-hole straddle packer system to evaluate outer tube (3) or casing (16) integrity and identify any point of concern, and embodiments enable complete repair/replacement of the HVHF-CGHEX with minimal surface impact while preserving the integrity and value of each well bore (which is the often most expensive component of a GeoEE system).
(iv) An ASUB2L that can preserve optionality should site conditions or thermal loads change with time by preserving clear, un-impeded access to a borehole so that it could be drilled deeper or modified should the site require: 1) additional borehole length due to changes to the site layout or increased thermal loads, or 2) changes to HVHF-CGHEX design. In certain aspects, an extension piece is provided for conveying borehole materials to the surface while protecting the interior portions of the ASUB2L from exposure. An extension pipe of suitable diameter may have a lower end outfitted with an adaptor like the outer portion (55) of the tube adaptor (26), which provides water-tight connections to pipe drill cuttings, produced air, water, etc. to the surface
(v) The use of “home run” piping arrangements to connect each HVHF-CGHEX (120) to a distribution and control center (121) equipped with or without a bank (122) of remote-control valves can enable isolation of an HVHF-CGHEX, taken off-line while others continue, thereby preventing system shutdown or loss of capacity from remaining HVHF-CGHEX. This can give the ability to address temporary failure or required service without impacting others. In certain aspects, the internal of any lateral can easily be inspected and/or tested as previously described in FIGS. 15A and 15B, and where the design permits, sequence control on the order of selection during cyclic exchange of one more HVHF-CGHEX can be managed as required.

In some embodiments, installation may proceed in a particular order. For instance, with respect to the arrangement of FIG. 1, a possible—though not exclusive—order for installation is:
1. Borehole cased and drilled to depth.
2. Immediate area excavated to depth below frost. Well casing (2 or 16) cut to elevation. Outer shell (20A, 20B or 21) attached to well casing (2 or 16) with adaptor (24A or 24B).
3. Lateral connections made to ports 29/29A and 32.
4. Surface riser (22) attached to outer shell (20A/20B/21).
5. Data telemetry conduit attached to porthole (27).
6. Excavation backfilled and compacted.
7. Outer tube (3) installed to depth through assembly (22 and, 20A/20B or 21).
8. Upon reaching total depth, adaptor (26A or 26B) is attached to outer tube (3) and set on bottom of outer shell (20A/20B/21).
9. Outer tube (3) inflated by filling with EEF.
10. Laterals (29/29A and 32) are flushed and purged using lateral flushing spool (57/70) to clear dirt and debris without directing downward.
11. Inner tube (6) installed to depth and connected to center tube connection (35 or 40).
12. Top of center tube (25) sealed with purge port (41) or outfitted with sensor adaptor.
13. Spool assembly (23/67) lowered into place within surface riser (22) and outer shell (20/21) till lower disc (38) lands on spool landing lip at top of lower chamber (30).
14. Locking bar (48) installed and secured with bolts (50).
15. Remaining air purged through center tube purge port.
16. Fully assembled device placed into service.

According to some embodiments, should an internal component need to be repaired or replaced, the spool assembly (23/67) can be released and retracted to provide access. For instance, if the outer tube (3) needs to be removed, the installation process is conducted in reverse using steps 14-7 and omitting step 10. As the fluid is removed, the liner deflates uniformly and pulls away from the borehole wall. It can then be pulled out for repair or replacement. One aspect of embodiments is that the process can occur without any excavation.

In another aspect of the disclosure, various operating modes for a heat exchange system are provided. The heat exchange operation may be based, for instance, on any of the designs described with respect to FIGS. 1-15.

According to embodiments an exchanger, such as an HVHF-CGHEX, supports operations with a continuous exchange, in which the EEF is circulated continuously while subject to a constant heat flux. The system also supports a cyclic exchange, where both the heat flux applied and the flow are intermittent. The cyclic exchange may have, for example, three distinct phases: (1) active heat exchange—a heat flux imparts a temperature differential (either positive or negative) to EEF being actively pumped from one or more heat pumps, or other ancillary components to one or more HVHF-CGHEX (or other equipped GHEX); (2) unloaded flow—flow occurs without intended heat flux for the purpose of redistributing EEF to manage temperature profile and facilitate thermal exchange with the borehole wall, and (3) static rest—no flow to enable the EEF volume additional time to exchange heat with the borehole wall through conduction, such that fully moderated EEF is then available to the heat pump(s) on start-up, increasing their Coefficient of Performance. Moreover, variations of the foregoing may be used according to embodiments.

In certain aspects, cyclic exchange can provide efficient transfer of a heat flux to the ground under a wide variety of operating scenarios and can moderate the EEF to achieve Entering Water Temperatures (EWT) close to the borehole wall temperature. Cyclic exchange may be implemented, for example, with an array of multiple HVHF-CGHEX, (or other GHEX) that are arranged to function akin to cylinders in an engine, by repeatedly cycling each through periods of active energy exchange, unloaded flow, and static rest. Continuous thermal energy is produced while giving each respective HVHF-CGHEX the rest time needed to complete the thermal exchange from the EEF to the borehole wall. The timing and duration of each phase of cyclic exchange is a function of time-variant thermal load requirements, the configuration of the device, the number of devices in the array, and other variables. The HVHF-CGHEX of embodiments supports multi-directional flow, and can alternate with variables such as load saturation, timing, and temperature, thereby driving decisions to remote-controlled valves incorporated in the surface distribution piping. In certain aspects, this design is hydraulically efficient; capable of 60+GPM with minimal pressure drops due to friction.

In some embodiments, the timing and duration of each active heat exchange period and each unloaded flow period are decoupled from each other and operate independently, where the active heat exchange period is of sufficient length to purge a stored volume, and with flow rate being one factor to determine length of time. In certain aspects, the length and timing of the unloaded flow period can be used to: (i) position EEF with the greatest temperature contrast adjacent to the borehole wall (1) to facilitate efficient thermal exchange, or (ii) position EEF at different depths within the HVHF-CGHEX to balance long term thermal exchange to one or more sections of the borehole. An unloaded flow period (89) can begin a specified amount of time before or after each active thermal exchange cycle (90) to clear the inner channel (A) of EEF containing any residual heat or chill. The EEF volume contained within a HVHF-CGHEX is provided sufficient time to rest, to transfer thermal flux between the EEF and the borehole wall, and to equilibrate to the temperature of the borehole wall. In embodiments, the optimum length of the static rest period is governed by factors such as borehole diameter (d), the length of the exchanger (L), and the formation properties (k and a) as well as other factors. Additionally, the length of the static rest period can be important to provide enough time for heat transfer to be completed between the EEF, the borehole wall, and surrounding formation.

In some embodiments, an entire HVHF-CGHEX assembly (e.g., comprised of in-borehole components and an ASUB2L) can be equipped with real-time, on-board instrumentation to create a smart system architecture enabling active and individual control of each HVHF-CGHEX, or groupings, to maximize overall system performance. The system may direct EEF to the primary heat pump loop, to an outside air exchanger, to solar thermal panels, to selected HVHF-CGHEXs, or to other such attached devices. This may be, for instance, for the purpose of efficiently managing the overall thermal budget within a GeoEE field. Using data from the system in conjunction with machine learning (ML) and artificial intelligence (AI), one can intelligently optimize a field's performance to take advantage of conditions, such as advective thermal transport from groundwater moving across the field.

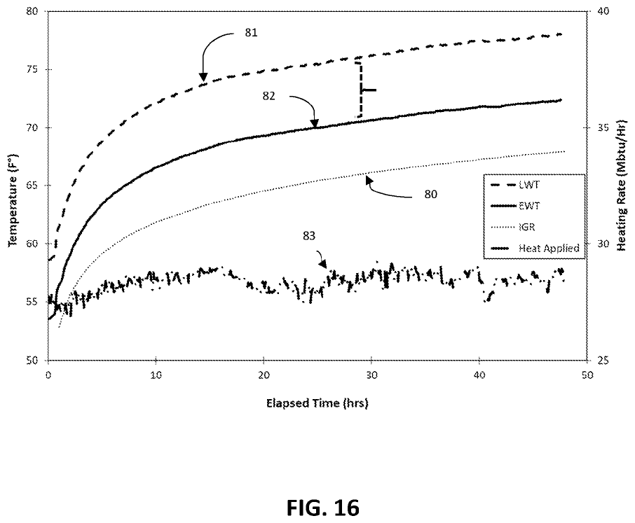

By way of example, Thermal Response Tests (TRTs) conducted on a six-inch diameter HVHF-CGHEX demonstrate: (1) effective thermal connection between the device and the surrounding geologic formation, (2) a lower borehole resistance (Rb), and (3) improved performance relative to existing GHEX designs installed in similar geologic formations. Heat exchange systems described herein can operate in a continuous mode, a cyclic mode, or both. However, cyclic exchange further improves the overall energy exchange capacity of HVHF-CGHEX by capitalizing on a substantial volume of EEF present within the device utilizing operating schemes where flow and heat transfer cycles are decoupled. FIGS. 16-23 illustrate operational and performance information of an example setup.

FIG. 16 presents results (a time vs. temperature plot) from a 48-hour thermal response test rejecting heat (A/C mode) to a 6″ diameter×290 ft. HVHF-CGHEX with a flexible outer tube (3). The plots illustrate an observed temperature of EEF. The dashed-LWT (81) and solid-EWT (82) curves show changes to EEF temperature over time in response to a constant 28,350 BTU/hr thermal load applied at a flow rate of 10.2 GPM. Delta T (5.5 degrees F.) is the vertical separation between EWT and LWT. It is a function of a thermal load applied and a flow rate. The Ideal Ground Response (IGR) (80) represents the theoretical temperature of a borehole wall (1) for a given borehole geometry, a thermal load applied and formation properties. It is completely independent of a GHEX design and provides a reference to measure the efficiency of any GHEX. The closer EWT (82) is to the IGR (80), the better. The trend (83) shows the time-variant magnitude of the thermal load applied and absorbed by the device.

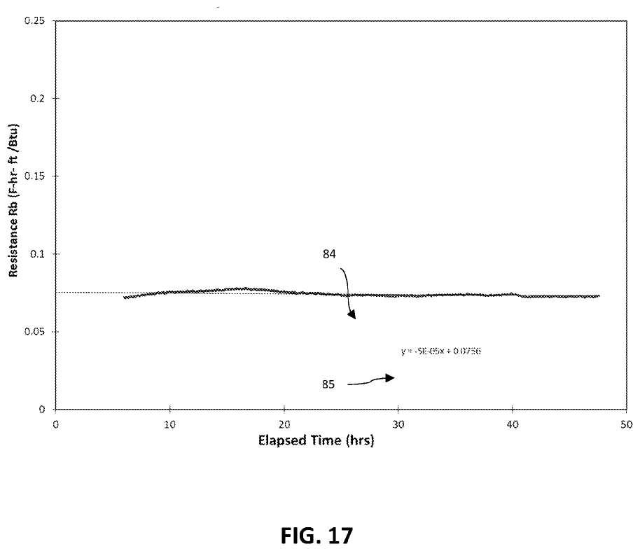

FIG. 17 plots the borehole resistance (84) of the device. Here, the line is nearly flat (85) as expected since Rb is a static condition specifically related to the design and materials of a GHEX. Rb is the temperature differential needed to drive a heat flux between the EEF (13) and the borehole wall (1) for an applied thermal load. In some embodiments, a substantial reduction in borehole resistance is provided, greatly enhancing thermal capacity and maximizing thermal transfer between the EEF and the borehole wall. Such designs may require less active exchanger length compared to traditional U-tube GHEXs.

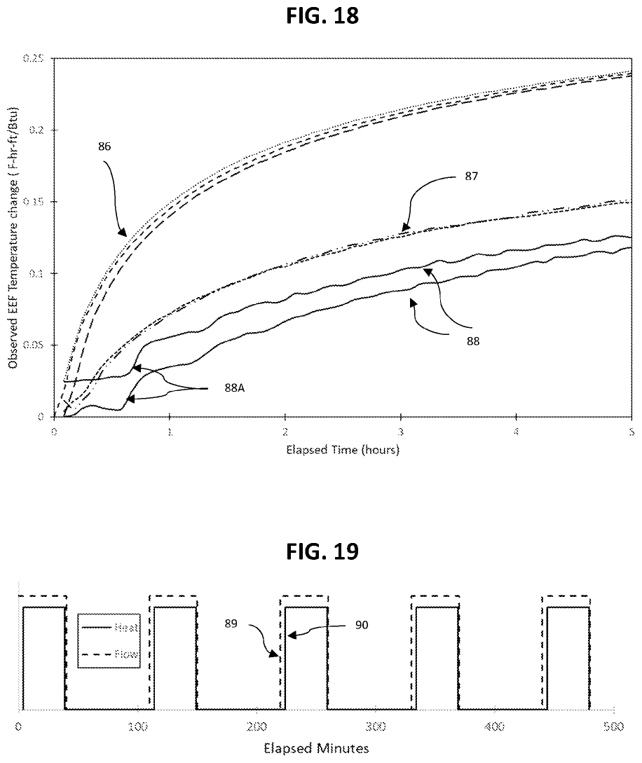

FIG. 18 presents normalized results (time vs. temperature) from constant injection thermal response tests (rejection of heat=simulating A/C mode) performed on several GHEX designs to illustrate relative efficiencies. Results were recorded during the first five hours of constant heating thermal response tests performed on a variety of GHEX designs installed in formations with similar thermal conductivity. This chart is interpreted as follows: the higher the curves, the more temperature differential required to move a heat flux from the EEF through a GHEX to the borehole wall. The 4 highest curves (86) are from 1.25″ u-tube GHEXs. The middle curves (87) are from another concentric design having a 3″ outer casing grouted in a borehole. The lowermost curves (88) are two tests performed on a 6″ diameter HVHF-CGHEX. In addition to being the lowest, the two tests also exhibit a delayed temperature increase (88A) at the start because of the substantially (16×) greater EEF volume contained in the device. The large volume can provide benefits when operating with cyclic exchange. In FIG. 18, normalized EWT responses are illustrated from various designs, and with ground conductivity K-1.9, and thermal load=1 BTU/Hr-ft of borehole.

According to embodiments, active management of cyclic exchange improves energy transfer by allowing an EEF volume contained within a HVHF-CGHEX sufficient time to rest, transfer heat, and equilibrate. Testing has shown that purging the stored volume followed by a rest period is optimum with the length of the rest being governed by borehole diameter (d), the length of the exchanger (L), and the formation properties (k and a) as well as other factors.

FIG. 19 is an example of a cyclic exchange where timing and duration of active heat exchange and unloaded flow are decoupled and operate independently (e.g., independent cyclic intervals controlling flow and heat applied to HVHF-CGHEX). Flow periods (89) can be longer and can be offset from the active thermal exchange period (90) to position EEF, for instance as shown with flow paths A B in FIGS. 1, 4, 5, and 6, with the greatest temperature contrast adjacent to the borehole wall 10, to facilitate efficient thermal exchange. In this instance, a cycle of 35 minutes of active thermal exchange (90) followed by 70-minutes static rest was used. Unloaded flow begins 4 minutes prior to each active thermal exchange cycle to clear the inner channel (A) of EEF containing any residual heat.

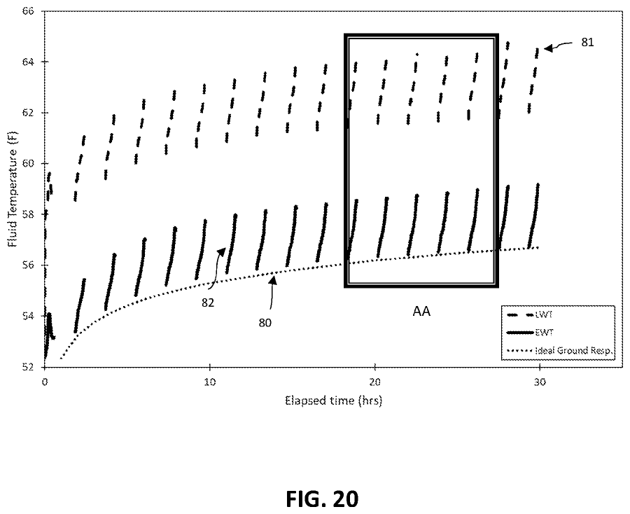

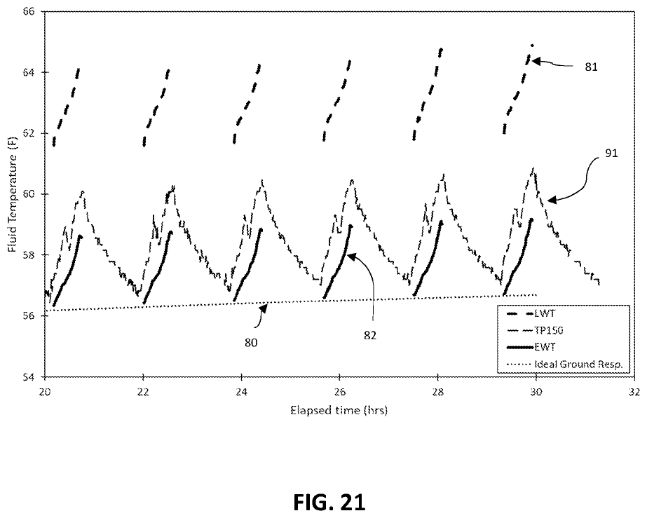

FIG. 20 and FIG. 21 present the results from a 31-hour thermal response test using this cyclic pattern and the rejection of heat (simulating A/C mode) to a 6″ diameter×290 ft. HVHF-CGHEX built with a flexible outer tube (3). FIG. 20 is a time vs. temperature plot recorded during cyclic thermal response, and FIG. 21 is a close-up inset of region AA shown in FIG. 20. The response for both LWT (81) and EWT (82) are now hashed segments (reflecting the cyclic pattern-on and off) that trend in tight ranges aligned along the IGR (80). The temperature sensor placed at 150-foot depth (91) exhibit a sawtooth pattern reflecting changes to FEF temperature in response to the cyclic pattern. The HVHF-CGHEX design and cyclic exchange enable EEF temperatures to recover during rest periods. The significance of the recovery is most apparent with EWT (82), which begins each cycle at lows that fall along the IGR (80), indicating parity with the ground temperature. EWT (82) then progresses approximately 2 degrees higher throughout the thermal exchange cycle (cycle average=1 degree). This performance is better than the constant test (FIG. 16) where EWT (82) was consistently 4.5 degrees above the IGR (80). Trending closer to the IGR (80) provides the highest efficiency and can allow a higher heat flux to be applied.

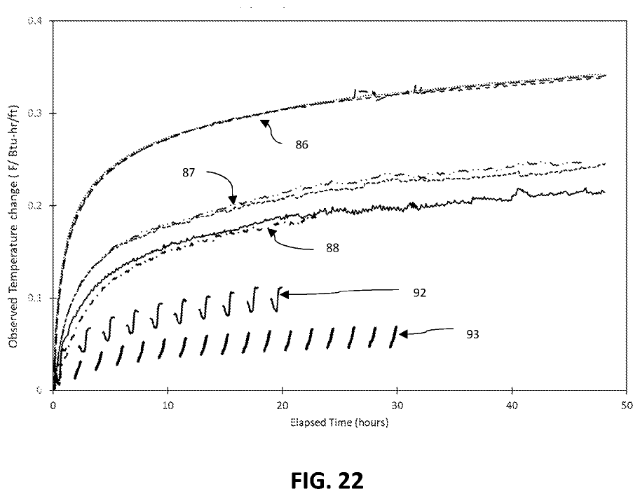

FIG. 22 illustrates normalized time vs. temperature plots of Entering Water Temperatures (EWT) recorded during thermal response tests performed on a variety of GHEX designs installed in formations with similar thermal conductivity. In particular, this figure presents an expanded view of EWT responses from normalized test results first presented in FIG. 18, but now includes results from two cyclic tests: (1) cyclic heat transfer with continuous flow (92); and (2) cyclic heat transfer with cyclic flow (93) utilizing the pattern presented in FIG. 19. While both cyclic modes perform far better than the constant injection alternatives, the latter (93) demonstrates the best performance. Again, ground conductivity was K=1.9 and the thermal load was 1 BTU/Hr-Ft of borehole.

In certain aspects, the HVHF-CGHEX of some embodiments is also designed for higher flow rates compared to conventional U-tube designs. For a given thermal load, higher flow rates reduce Delta T (LWT-EWT) according to the following equation:

$$Δ T \times Flow ( gpm ) \times 500 = Thermal load ( Btu ’ s per hr ) ,$$

and can be a factor when avoiding freezing conditions for EEF during heat extraction. Higher flows minimize temperature separation for an applied thermal load and may help avoid the hard boundary condition.

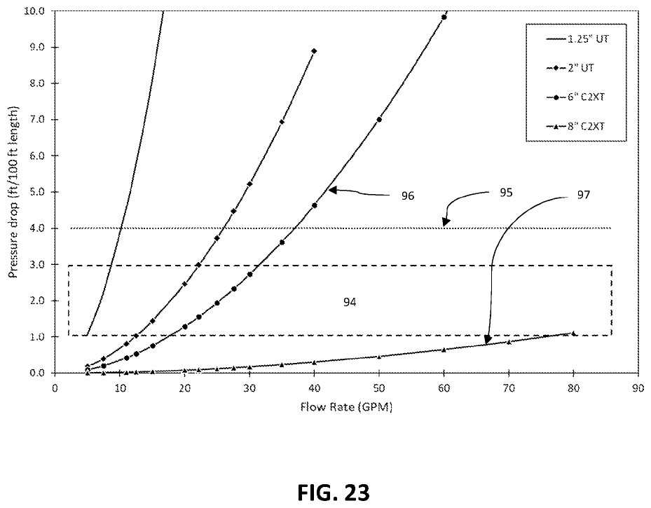

FIG. 23 presents the pressure drop curves (e.g., due to friction loses) associated with two models of the HVHF-CGHEX design, along with U-tube designs for comparison. GeoEE design practices specify that pressure drops of 1-3 Ft/100 ft (see box 94) are acceptable but should never exceed 4 ft. per/100 ft (95). Proper hydraulic design is important to managing pumping costs. Both HVHF-CGHEX models provide very high flows with minimal losses. In some embodiments, the 6″ HVHF-CGHEX (96) is capable of up to 30 GPM, while the 8″ (97) can support flows over 70 GPM, which is nearly 8× greater than a conventional U-tube.

According to embodiments, one or more of the designs may be hydraulically capable of achieving high GPM with minimal pressure drops due to friction. Higher flow rates are available to tighten the spread of Delta T. and designs can assist in avoiding the hard boundary condition of freezing during thermal extraction. Higher flows also reduce cross-channel heat loss, and can increase heat flux from greater turbulent flow, for instance flow in channel B along the outer tube (3) or casing (16).

Certain Benefits of embodiments may be derived from using a large volume, high flow, individual control and cyclic exchange together on a larger scale in an array of HVHF-CGHEX to change the operational paradigm from “all on, all the time” to a cyclic mode where each HVHF-CGHEX functions as a cylinder providing its maximum output for a short segment of time followed by recovery.

FIG. 24 provides a simplified example layout of Cyclic-Cylinders (CC) according to embodiments. In this example, six exchange systems are used, which are individually piped. Each HVHF-CGHEX (120) or other exchanger is piped to a distribution and control center (121) having a bank of remote-control valves (122) to direct flow. In addition to sequence control, the benefit from piping each pair of laterals (123) as “home-runs” enables any HVHF-CGHEX to be taken off-line without losing the capacity of the remaining installations, should one suffer temporary failure or require service. Furthermore, any of the laterals can easily been inspected and/or tested as previously described with respect to FIGS. 15A and 15B. In this example, each HVHF-CGHEX operates on a 33% duty cycle, with two in the array actively providing EEF to the heat pump loop (124) at any time. As the cycles (125) progress, the active “cylinder” selection advances through an array, causing the active to “fire their piston” while providing others with rest time for recharge. Other duty cycles may be used. In certain aspects, optional top head sensors on each HVHF-CGHEX (previously described) can provide feedback to assist with the adjustment timing and flow rates, etc. to achieve optimal performance. Further, these inputs can be also used to enable AI and ML to make additional refinements and adjustments as operating conditions change. Aspects of the disclosure allow for the addition of an optional third auxiliary pipe (126) to a distribution and control center which may be installed to supply EEF from an optional piping arrangement to assets such as one or more solar thermal arrays, one or more air chillers, or other auxiliary devices which may augment management of thermal loads as part of a Smart System architecture.

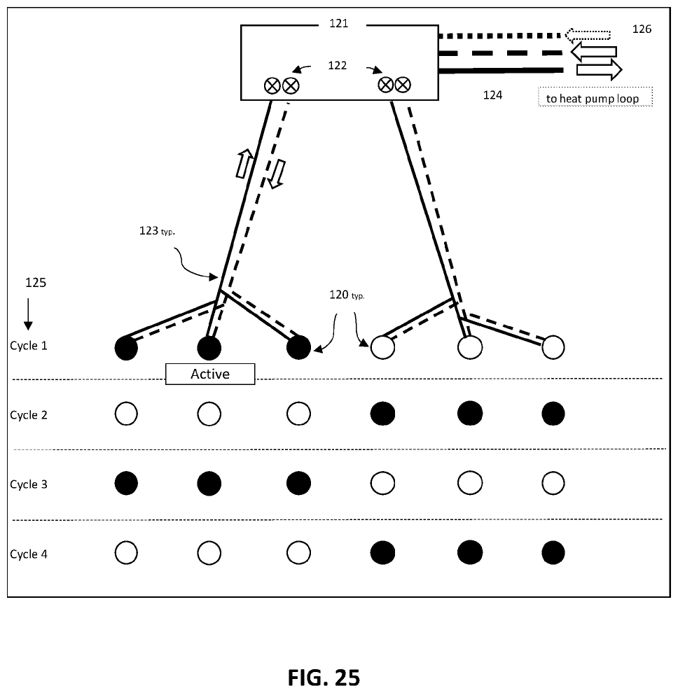

It is also possible that two or more HVHF-CGHEXs (or GHEXs) may share a common trunk lateral depending upon site layout and design requirements. FIG. 25 depicts an example of a “squad” connection strategy, with the cyclic cylinder operating paradigm on an array of six HVHF-CGHEXs or other exchangers piped in “squads” to a distribution and control center equipped with remote control valves managing flow sequence. Flow variation can become a concern with different piping layouts and lengths. In this embodiment, squad flows are managed by a bank of valves (122) in a distribution and control center (121) while individual HVHF-CGHEX flows are balanced and managed using the side port orifice (43) on an ASUB2L spool assembly (23, 67). In this example, each HVHF-CGHEX squad operates on a 50% duty cycle, with three actively providing EEF to the heat pump loop (124) at any time. As the cycles (125) progress, the cylinder sequence swaps the active squad while providing rest time for the other. The same optimization and thermal management techniques described elsewhere can also be applied to “squad” configurations.

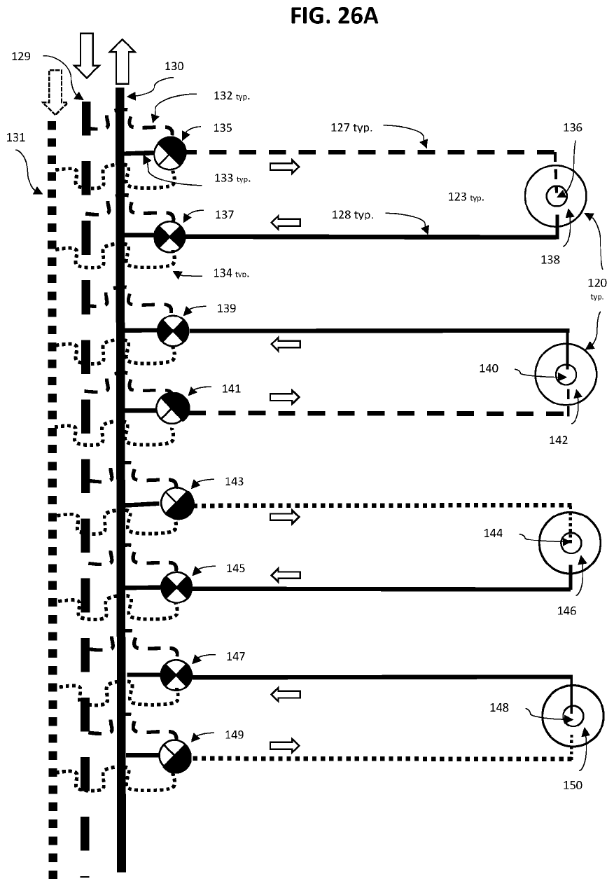

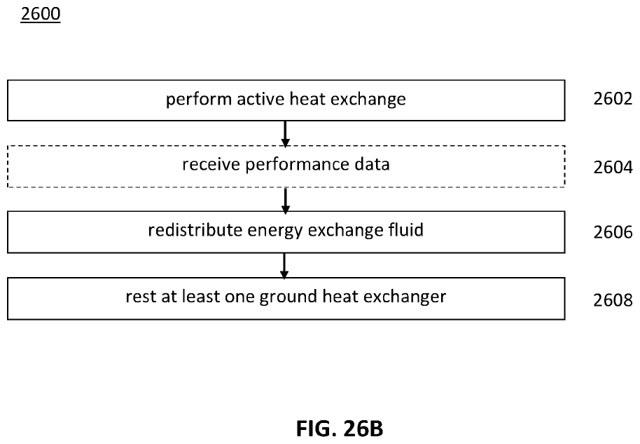

FIG. 26A is an example schematic that illustrates piping and valve arrangements which may be deployed within a distribution and control center demonstrating according to embodiments. In certain aspects, FIG. 26 also illustrates how active management of flow is accomplished in some embodiments. In this example, each HVHF-CGHEX or other GHEX (120) is piped to a distribution and control center using a pair of lateral pipes (123 typ.). In embodiments, the pipes may be fabricated from HDPE or other suitable materials. One lateral (127 typ.) is connected to flow channel A (see FIG. 1, 4, 5, or 6) via an ASUB2L, while the other lateral (128 typ) is connected to flow channel B (see FIG. 1, 4, 5, or 6) via an ASUB2L. Here, each lateral (127; 128) is connected to dedicated control valves (135/137) having three selectable ports which are connected to the distribution mains in the following manner typical of all valves. The LWT main (129) connects via jumper 132, the EWT Main (130) connects via jumper 133, and the optional auxiliary pipe (131), from other thermal assets, connects via jumper 134. The selected position of a valve pair (e.g., 135,137) determines the source and direction of flow to a GHEX (120) via laterals 127 and 128.

According to some embodiments, four flow cases are presented to demonstrate aspects of the flexibility in the design:
(i) Center flow down—Valve 135 sends flow from LWT (129) out to channel A (136) via 127 causing EEF to travel down the center of an exchanger (120). Flow returns up the annular channel B (138) and returns via 128 where valve 137 directs the flow into the EWT main (130) for return to the heat pump loop.
(ii) Annular flow down—Valve 141 sends flow from LWT (129) out to channel B (142) causing EEF to travel down the annular region (142) of an exchanger (120). Flow returns up the center channel A (140) and return to valve 139 which directs the flow into the EWT main (130) for return to the heat pump loop.
(iii) Auxiliary Center flow down—Valve 143 sends flow from AUX (131) out to channel A (144) causing EEF to travel down the center of an exchanger (120). Flow returns up the annular channel B (146) and returns to valve 145 which directs the flow into the EWT main (130) for return to the heat pump loop.
(iv) Auxiliary Annular flow down—Valve 149 sends flow from AUX (131) out to channel B (150) causing EEF to travel down the annular region (150) of an exchanger (120). Flow returns up the center channel A (148) and returns to valve 147 which directs the flow into the EWT main (130) for return to the heat pump loop.
   The selections can be dynamic and can be specific to certain GHEX (120), or may also vary with time depending upon thermal requirements. In the example of FIG. 26A, the black segments on the valves indicate connected flow paths.

According to embodiments, the systems of FIGS. 24, 25, and 26A can use the other systems and devices described herein, such as the heat exchangers of FIGS. 1-6 and adapters of FIGS. 7-12. In some embodiments, the layout of the Cyclic-Cylinders (CC) is designed to distribute the energy exchange over a broader geographic and/or vertical portion of the geologic formation to enable the overall GeoEE to transmit the thermal energy more effectively. Some example setups could include:
(i) each HVHF-CGHEX operating on a prescribed duty cycle, which may range from 10-100%;
(ii) a duality of valves (e.g., 135/137) are connected to the laterals (127/128) to control the source and direction of flow to a HVHF-CGHEX (120);
(iii) as the cylinder-cycling (125) progresses, the selection of one or more HVHF-CGHEX for active exchange advances through an array, causing the active device to “fire their piston” while other devices move to or remain in the static rest period;
(iv) optional sensors on each HVHF-CGHEX can provide feedback to assist with the adjustment timing and flow rates, etc. for the entire GeoEE field to achieve optimal performance; and/or
(v) the sensor inputs can also be used to enable AI and ML to make additional refinements and adjustments to manager performance as operating conditions change.

Referring now to FIG. 26B, a process 2600 is provided according to some embodiments. The process may be performed, for instance, using the exchange systems of FIG. 24, FIG. 25, and FIG. 26A. The process may begin, for example, with step 2602 and performing an active heat exchange. In step 2604, which may be optional in some embodiments, performance data is received (e.g., from one or more of the ground heat exchangers and/or adapters). In certain aspects, one or more of the other steps of process 2600 may be responsive to the received data. This could include, for instance, selection of a heat exchanger or group of exchangers for a particular phase, selection of phase time, selection of flow rates, etc. In step 2606, energy exchange fluid (EEF) is redistributed. In step 2608, at least one of the ground heat exchangers is rested.

In another aspect of the disclosure, a method and apparatus for the vertical segmentation (V2SEG) of a GHEX are provided according to some embodiments.

According to embodiments, a HVHF-CGHEX or other exchanger is partitioned into at least two or more separate and distinct vertical segments operating in the same borehole. This may be used, for instance, in applications where there is a high thermal load and/or the need maximize the use of available footprint, formation properties, and/or cost. In this embodiment, the two segments operate akin to stacked cylinders each having a specified “rest” period. The “two-in-one” borehole provides a cost advantage. The marginal cost of extra length may be cheaper than two boreholes, by reducing set-up and drilling costs, while requiring only one surface completion and a single set of lateral piping. While examples use segmentation into two segments, embodiments can be extended to three or more segments in the same fashion.

In one embodiment, a ported inflatable packer (PIP) within the HVHF-CGHEX separates flow to either the upper or lower segments. A series of pipes connect the PIP to the Surface Control Valve (SCV). In certain aspects, the SCV can be built into embodiments of the ASUB2L center spool. Valve selection directs flow to the appropriate ports for the PIP. The SCV is also capable of handling multi-directional flow.

FIG. 27 provides a schematic of the V2SEG components in a two-segment embodiment. A PIP (170) is connected to an upper inner pipe (171) that is attached to the center port of the SCV (174), a lower inner pipe (172) that extends to total depth, and a single offset pipe (173) that extends from the SCV (174) to the PIP (170) to hydraulically connect the lower annular volume (175) to the SCV (174). The upper annular volume (176) directly communicates with the annular port (177) on the SCV (174). The PIP (170) is positioned to partition a HVHF-CGHEX into two distinct, isolated segments where flow is directed to either the lower (179) or upper (178) segments.

In some embodiments, a Surface Control Valve (174) directs flow to the proper channels, and thus, the proper segmented regions (e.g., either channels A/B or C/D in this example). With respect to the example illustrated in FIG. 27, for an upper segment (178) to be active, the SCV (174) shifts to position C/D (180). EEF flows down through the annular port (177/198) and continues down the upper annular (176) (FLOW channel C), passes through ports (189) in the PIP (170) and returns to the SCV (174) via the upper inner pipe (186/171) (FLOW channel D) and in through center port (197). The offset pipe port (196) is blocked preventing flow within the offset pipe (173) and the lower annular volume (175). For a lower segment (179) to be active, the SCV (174) is shifted to position A/B (181) EEF flows through the center port (197) down the inner pipes (171, 172) (FLOW channel A) and returns by moving up through the lower annular (175) (FLOW channel B) and returns to the SCV (174) via the offset pipe (173), exiting through the offset port (196). The annular port (177/198) is blocked preventing flow in an upper section (176).

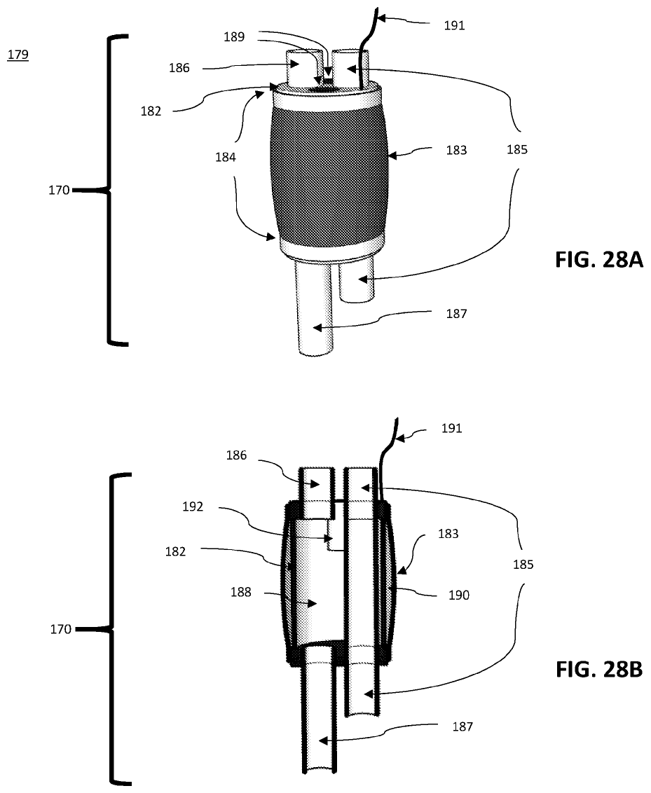

According to some embodiments, FIGS. 28A and 28B provide isometric and cut-away views of the Ported Inflatable Packer (170). The packer is used to separate and isolate the well bore into two sections. Additional PIPs may be used to form additional sections.

In some embodiments, the PIP comprises a rigid, hollow cylindrical body (182) having two sets of pipes attached to either end which is wrapped with an expandable rubber sleeve (183) secured to the rigid cylinder (182) at either end with two hose clamps (184). An offset pipe, such as offset pipe (173), connects to the upper offset connection (185) which continues through the rigid body (182) and terminates a few inches below the packer body (182), providing the hydraulic connection to the lower annular region (175). The connections for the upper (186)/lower (187) inner pipes are different according to some embodiments. Unlike the offset pipe connection (185), they are not continuous through the interior of the packer body (182). The break enables EEF to flow to either the upper active section (178) or the lower active section (179) depending upon the direction of flow established by the SCV (174). Two holes (189) in the top of the packer body (182) provide the hydraulic connection between the upper annular region (176), the interior of the packer body (188), and the upper center tube connection (186).

The PIP (170) may be provided in a variety of sizes (diameter and length) to fit outer tubes (3) or well casings (16) of various diameters. The outside diameter of a deflated, relaxed PIP (170) may be 1″-1.5″ less than the diameter of the tube (3) or casing (16) to permit ease of installation, according to some embodiments. The PIP (170) can be installed by adding the calculated length of lower inner pipe (172) needed to reach desired depth based upon the final depth of the PIP (170) The upper inner pipe (171) as well as the offset pipe (173) are then connected to their respective connections (186,185) on top of the PIP (170) and are used to hold, lower, and finally position the PIP (170) at the desired depth using appropriate lengths of the upper inner pipe (171) and offset pipe (173). In some embodiments, the packer sleeve (183) is inflated by forcing water, other fluids, or even gas into the cavity (190) between the packer body (182) and the sleeve (183) via a length of inflation tube (191) that extends to the surface, which was also installed concurrent with the pipes. Once the packer (170) is in place, the sleeve (183) is inflated, causing its mid-body diameter to expand, to contact either the outer tube (3) or casing (16) and to isolate the two sections directing all flow through the PIP (170). The top of the inflation tube (191) is then shut in and left in a pressurized state. In certain aspects, the cavity (190) between the packer body (182) and the rubber sleeve (183) permits fluid to be evenly distributed along the circumference of the packer body (182) to evenly inflate the sleeve (183).

According to some embodiments, should removal of the PIP (170) be required, the pressure is removed from the inflation tube (191), which causes the cavity (190) to empty and allows the sleeve (183) to collapse and reduce its diameter. The entire assembly is then removed by removing sections of the upper inner pipe (171) and offset pipe (173).

When the SCV (174) makes the upper section (178) active, flow descends through the upper annular region (176), enters the through holes (189) in the top of the body (182), passes through the packer body interior (188), and then returns to the surface through the upper inner pipe connection (186) and the upper inner pipe (171). No flow occurs in down the lower inner pipe (187/172) since no flow can move in the lower annular region (175) as the SCV (174) has blocked any flow exiting the offset pipe (185/173). According to some embodiments, whenever, the SCV (174) activates the lower section (179), it directs fluid down the upper inner pipe (171) which enters the interior (188) via port (186). Self-cleaning and low-maintenance rubber duckbill valves (192) and the blocked annular port (177) may be used to prevent EEF from flowing up through holes (189). The EEF is thereby forced to continue into the lower inner pipe connection (187) and to depth via the lower inner pipe (172). The returning fluid passes through the PIP (170) via the offset pipe connection (185) and returns to the SCV (174) via the offset pipe (173).

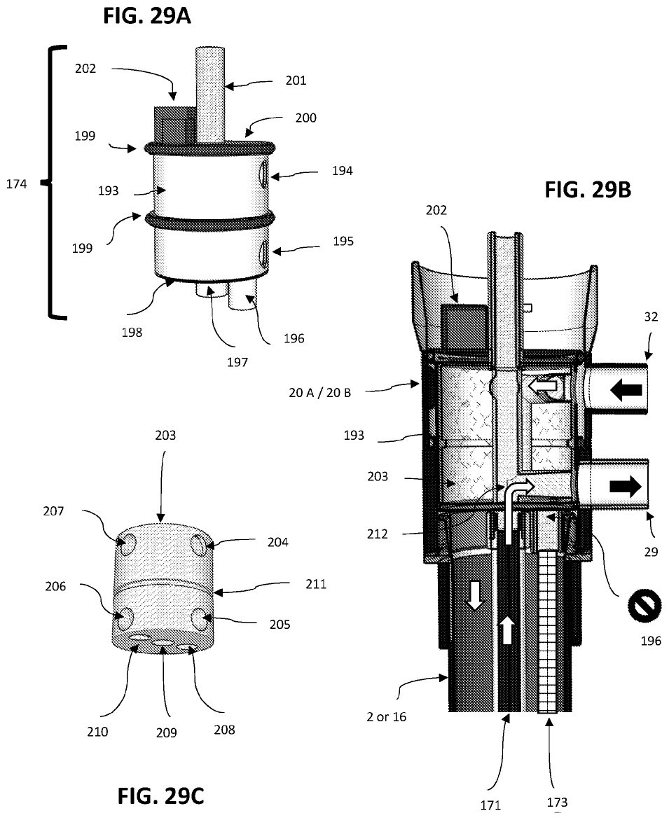

FIGS. 29A, 29B, and 29C provide detailed views of a Surface Control Valve (174) according to some embodiments. The outer case (193) has similar dimensions and functions to other embodiments of the ASUB2L center spool assembly (23) and fits within the ASUB2L outer shell (20A/20B). The upper lateral port (194) and the lower lateral port (195) align with their respective lateral connections (32/29) on an ASUB2L-O/U outer shell (20A/20B) or other adapter. In this example, their flow channels are isolated by a series of O-rings (199) that wrap-around the case (193). In this depiction, as with others, flow is shown entering through the upper lateral (32) and exiting through the lower (29), although multi-directional flow is possible. Three ports located on the under-side of case (193) direct flow to the vertical pipes and annular regions, as shown on FIG. 27. The offset pipe (173) connects to the OP receiver (196), while the upper inner pipe (171) connects to the IP receiver (197). The upper annular port (198/177) is located radially behind the IP receiver (197). A removable top (200) provides access to the valve barrel (203) located within the case (193). The center stem (201) functions like the center stem described previously for the other spool assembly (23) and is outfitted with the top cap (41, not shown) or plug. An actuator (202) shifts the rotary position of the valve barrel (203) to align openings (204/205 or 206/207) with their respective lateral ports (194/195), and openings (208-210) with their respective ports (196-198) on the bottom of case (193). Additional power and sensors may be used to operate the SCV (174) and interface with the top head micro-controller previously described.

According to some embodiments, the SVC valve barrel (203) has internal channels (212) that direct flow from lateral openings (204-207) to the appropriate openings on the bottom (208-210). The flow paths can include: (i) opening 204 that connects to opening 208; opening 206 that connects to opening 210; and openings 205 and 207, which both connect to opening 209. In embodiments, an O-ring (211) and seals within the case (193) can allow flow in those channels only when their openings (204-210) are aligned with the case ports (194-198). The two sets of lateral openings (204/205) and (206/207) are oriented more or less 90 degrees apart along the axis of the barrel (203), while the bottom openings (208-210) are aligned along the diameter. Conversely, the bottom ports (196-198) on the bottom of the case (193) are oriented between 50 and 110 degrees (depending upon channel size). This is shown, for instance, with respect to 180 and 181 of FIG. 27. Additionally, and in some embodiments, rotation of the barrel valve (203) aligns valve openings with the ports/pipe connections to direct EEF into either upper segment (178) having flow channels C and D or into lower segment (179) having flow in channels A and B. The SCV (174) swaps flow segments according to the cyclic-cylinder pattern being employed. Overall flow management to the HVHF-CGHEX is controlled by the distribution valves (122).

### SUMMARY OF EMBODIMENTS

(Group A Embodiments) A1. A system for heat exchange, comprising: a first tube; and a second tube arranged concentrically within the first tube.

A2. The system of A1, wherein the first tube is formed of a flexible material.

A3. The system of A1 or A2, further comprising: one or more centralizers or turbulators arranged between the first and second tube (e.g., wherein the centralizers or turbulators are mounted on an outer surface of the second tube).

A4. The system of A3, wherein at least one of the centralizers comprises: a plurality of fins arranged about a longitudinal axis of the centralizer (e.g., in a spiral configuration to form a helix); a plurality of sections; and/or at least one section having a tapered width (e.g., wherein a width of the centralizer is narrower at one or more ends of the centralizer than at the mid-point of the centralizer, or wherein the centralizer has a spiral-fluted shape).

A5. The system of any of A1-A4, wherein the first and second tubes have relative widths of between 2×-3× (e.g., the outer tube is between 2-3 times as wide as the inner tube).

A6. The system of any of A1-A5, further comprising: an adapter according to any of the Group C Embodiments.

A7. The system of A6, further comprising: lateral piping, wherein the adapter provides a subsurface fluid connection between the first tube and the lateral piping and between the second tube and the lateral piping.

A8. The system of any of A1-A6, further comprising: a ground borehole having an outer wall, wherein the first tube is in direct contact with the borehole wall (e.g., without grout).

A9. The system of any A1-A8, wherein the first and second tubes are arranged vertically and underground to form a ground heat exchanger.

A10. The system of any of A1-A9, wherein the at least one of the first and second tubes are vertically segmented by a partition to form an upper heat exchanging region and a lower heat exchanging region.

A11. The system of A10, wherein the partition is a ported inflatable packer (PTP).

A12. The system of A10 or A11, further comprising: a surface control valve (e.g., in the spool of an adapter), wherein the control valve has a first setting that restricts fluid flow to the upper thermal exchanging region, and wherein the control valve has a second setting that enables fluid flow in the lower thermal exchanging region.

A13. The system of any of A1-A12, wherein the first tube has a diameter of at least 5 inches (e.g., between 6-8 inches) and/or the inner tube has a diameter of at least 1.5 inches (e.g., between 2-4 inches).

A14. The system of any of A1-A13, wherein the system has an EEF volume per depth of at least 0.100 ft³/ft (e.g., between 0.100 and 0.350 ft³/ft).

A15. The system of any of A1-A14, wherein the flexible material comprises one or more of:
(i) PVC,
(ii) smooth or soft PVC in combination with a one or more plies of thread-like material wrap,
(iii) lay flat discharge hose, and/or
(iv) a material having an operating temperature in the range of −5 F to 170 F degrees.

A16. The system of any of A6-A15, wherein the adapter is connected to the top of the first tube and the top of the second tube (e.g., with bolts, a gasket, and/or a landing plate and casing adapter configured to form a water-tight seal to the first and second tubes, or other connection type).

(Group B Embodiments) B1. A method for a heat exchange system, comprising: inserting a first tube into a borehole; and inflating the first tube to form a fluid channel.

B2. The method of B1, wherein the first tube is formed of a flexible material.

B3. The method of BI or B2, wherein the first tube is folded and/or clamped with a restraint during insertion, further comprising: removing the restraint.

B4. The method of any of B1-B3, wherein the first tube comprises a weight (e.g., an external or internal weight).

B5. The method of B4, further comprising: removing the weight after inflating the first tube (e.g., by lowering a wireline overshot on a cable, latching to a receiver on a top of the weight, and then retrieving the weight by retracting the cable).

B6. The method of any of B1-B5, wherein the first tube forms an outer fluid channel, further comprising: inserting a second tube into the first tube to form an inner fluid channel.

B7. The method of any of B1-B6, wherein the inflating causes the first tube to conform to the borehole wall.

B8. The method of any of B1-B7, wherein one or more of the inflating or removing the restraint comprises filling the first tube with water.

B9. The method of any of B6-B8, further comprising: attaching adapter to the first and second tubes (e.g., an adapter according to any of the Group C Embodiments).

B10. The method of B9, further comprising: attaching the adapter to a plurality of lateral fluid pipes.

B11. The method of any of B1-B10, further comprising: vertically segmenting the heat exchanger.

B12. The method of B11, wherein vertically segmenting the heat exchanger comprises: inserting a ported inflatable packer (PIP) into the first tube to form an upper flow region and a lower flow region; and connecting the PIP with a surface control valve.

B13. The method of any of B1-B12, further comprising: drilling the borehole (e.g., into bedrock material).

B14. The method of any of B1-B13, further comprising: measuring one or more of temperature, pressure, and flow of a fluid in the heat exchange system (e.g., according to any of the Group G Embodiments).

B15. The method of any of B1-B14, further comprising, operating the heat exchange system (e.g., by flowing water or another EEF through the inner and outer channels formed by the first and second tubes).

B16 The method of B15, wherein the operating comprises a cyclic exchange of fluid through the first and second tubes (e.g., according to any of the Group F Embodiments) or performing one or more flush or access operations (e.g., according to any of the Group D embodiments).

B17. The method of any of B1-B16, wherein the method is for installing a system of any of the Group A, Group C, or Group E Embodiments.

B18. The method of B12-B17, wherein the vertical segmentation comprises removing an inner spool of the adapter and inserting one or more of an SCV spool, additional piping, and/or PIP.

(Group C Embodiments) C1. A heat exchanger adapter, comprising: an outer shell, wherein the outer shell has a first fluid port and a second fluid port; and an internal spool assembly.

C2. The adapter of C1, wherein the internal spool assembly is removable.

C3. The adapter of C1 or C2, wherein the internal spool assembly is configured to direct fluid flow between at least two vertical flow paths of a concentric ground heat exchanger and the first and second fluid ports.

C4. The adapter of any of C1-C3, further comprising one or more of: a locking bar; or a casing adapter (e.g., configured to mate with the borehole casing or landing plate of a heat exchanger).

C5. The adapter of any of C1-C4, further comprising: one or more measurement ports (e.g., for monitoring water temperature in one or more flow paths through the adapter); and/or one or more temperature or pressure sensors (e.g., installed in the one or more ports).

C6. The adapter of any of C1-C5, wherein the adapter is a subsurface adapter, further comprising: a surface riser (e.g., comprising a power or data telemetry conduit).

C7. The adapter of any of C1-C6, wherein the first port is located above the second port at an outer surface of the shell (e.g., the apparatus is an ASUB2L-O/U).

C8. The adapter of C7, wherein the outer shell comprises: an upper flow chamber; a lower flow chamber; and one or more separation discs (e.g., mounted to a center tube of the adapter) arranged between the upper and lower flow chambers.

C9. The adapter of any of C1-C6, wherein the first and second ports are arranged at the same elevation at an outer surface of the shell (e.g., the apparatus is an ASUB2L-S/E).

C10. The adapter of C9, wherein the outer shell comprises: a first flow chamber; a second flow chamber; and a separation disc configured to provide a boundary between the first and second flow chambers, wherein the separation disc is arranged at an angle (e.g., it is arranged in a plane that is not orthogonal to the surface of the outer shell or the flow channels of the heat exchanger).

C11. The adapter of C10, further comprising: a lower disc, wherein the lower disc comprises a window that is configured to allow fluid to flow between the bore of a ground heat exchanger and the first or second fluid port.

C12. The adapter of any of C9-C11, wherein the first fluid port and second fluid port are arranged on opposite sides of the adapter.

C13 The adapter of any of C1-C12, wherein the spool assembly is a removable flushing spool that couples the first fluid port to the second fluid port.

C14. The adapter of C13, wherein the first and second ports are arranged in an over-under configuration at an outer surface of the shell (e.g., the apparatus is an ASUB2L-O/U), and wherein the flushing spool comprises u-shaped connection between the first and second ports.

C15. The adapter of C13, wherein the first and second ports are arranged at the same elevation at an outer surface of the shell (e.g., the apparatus is an ASUB2L-S/E), and wherein the flushing spool comprises a straight connection between the first and second fluid ports.

C16. The adapter of any of C13-C15, wherein the outer shell has a stepped diameter (e.g., to interface with the channels of a ground heat exchanger)

C17. The adapter of any of C1-C12, wherein the spool assembly is a removable lateral access spool.

C18. The adapter of C17, wherein the spool comprises a first conduit that extends through a first (e.g., upper) chamber of the spool and provides surface access to the first fluid port (e.g., for access to an upper lateral).

C19. The adapter of C17 or C18, wherein the spool comprises a second conduit that extends through a second (e.g., lower) chamber of the spool and provides surface access to the second fluid port (e.g., for access to a lower lateral).

C20. The adapter of any of C1-C19, further comprising: a center tube.

C21. The adapter of C20, wherein the center tube comprises an inlet or outlet port, supports one or more separation discs, comprises at least one measurement or power port, and/or is adapted to interface with a central flow channel of the heat exchanger.

(Group D Embodiments) D1. A method in a ground heat exchanger having an adapter, comprising operating the ground heat exchanger using a first removable internal spool of the adapter: removing the first removable internal spool from the adapter; inserting a second removable internal spool into the adapter, wherein the second removable internal spool provides a different functionality than the first removable internal spool; and operating the ground heat exchanger using the second removable internal spool.

D2. The method of D1, wherein operating using the first removable internal spool comprises flowing water or another EEF through one or more ground channels of the heat exchanger (e.g., through first and second vertical in-ground tubes of the exchanger).

D3. The method of D1 or D2, wherein operating using the second removable internal spool comprises performing a flushing operation with respect to at least one lateral connected to the adapter of the heat exchanger

D4. The method of D1, wherein the flushing operation comprises flowing water or other EEF internally between first and second ports of the adapter, and without permitting fluid flow to any heat exchange channels of the ground heat exchanger.

D5. The method of D1 or D2, wherein operating using the second removable internal spool comprises performing an access operation with respect to at least one lateral connected to the adapter of the heat exchanger.

D6. The method of D5, wherein the access operation comprises insertion ofa measurement tool or other device (e.g., camera) into a lateral connected to the adapter, and without removal of the adapter.

D7. The method of any of D1-D5, further comprising: removing the inner spool and accessing the borehole (e.g., to repair or modify the borehole, such as changing liner, repair a hole, deepen, adding a PIP).

D8. The method of any of DI-D7, wherein the ground heat exchanger is a system according to any of the Group A or Group E Embodiments and the first and second internal spools are according to any of the Group C Embodiments.

(Group E Embodiments) E1. A heat exchange system, comprising: a plurality of ground heat exchangers; a fluid distribution and control unit; and a plurality of pipes interconnecting the plurality of ground heat exchanges with the distribution and control unit.

E2. The system of E1, wherein the distribution and control unit comprises a plurality of valves configured to control fluid flow through the pipes and between the distribution and control unit and the ground heat exchangers.

E3. The system of E2, wherein the valves are remotely controllable.

E4. The system of any of E1-E3, wherein each of the ground heat exchangers is individually connected to the distribution and control unit by at least one of the pipes (e.g., a pair of “home run” pipes).

E5. The system of any of E1-E3, wherein a first set of the plurality of ground heat exchangers are interconnected and form a first group of heat exchangers, and wherein a second set of the plurality of ground heat exchangers are interconnected and form a second group of heat exchangers.

E6. The system of E5, wherein the first group of heat exchangers are connected to the distribution and control unit by a first common pipe, and wherein the second group of heat exchangers are connected to the distribution and control unit by a second common pipe.

E7. The system of any of E1-E6, further comprising: a controller (e.g., remote or co-located with the distribution and control unit).

E8. The system of E7, wherein the controller comprises a processor configured to perform any of the Group F Embodiments.

E9. The system of any of E1-E8, wherein the fluid distribution and control unit comprises: a first port for a first lateral connection to a first ground heat exchanger comprising a first control valve; and a second port for a second lateral connection to the first ground heat exchanger comprising second control valve.

E10. The system of E9, wherein the distribution and control unit further comprises: a third port for a third lateral connection to a second ground heat exchanger comprising a third control valve; and a fourth port for a fourth lateral connection to the second ground heat exchanger comprising fourth control valve.

E11. The system of E9 or E10, wherein each of the control valves is configured with two or more selectable positions (e.g., enabling flow to an LWT main, or enabling flow to an EWT main, or enabling flow to an auxiliary pipe).

E12. The system of E11, wherein the selected position of a pair of the control valves determines the source and direction of fluid flow to the first and/or second ground heat exchangers (or first and/or second groups of heat exchangers) via the laterals.

E13. The system of any of E1-E12, further comprising: at least one external system (e.g., a heat pump loop, outside air exchanger, solar thermal panels) fluidly coupled (e.g., via an auxiliary pipe) to the distribution and control unit.

(Group F Embodiments) F1. A method of operating a plurality of ground heat exchangers, comprising: performing active heat exchange with at least one of the ground heat exchangers; redistributing an energy exchange fluid (EEF) within or between the plurality of ground heat exchangers; and resting at least one of the ground heat exchangers.

F2. The method of F1, wherein the active heat exchange comprises flowing EEF having a first temperature, wherein the first temperature is selected/controlled to cause ground heat exchange with the FEF

F3. The method of F1 or F2, wherein redistributing comprises flowing EEF having a second temperature, wherein the EEF flow is selected/controlled to move a thermal EEF load within the one or more of the heat exchangers.

F4. The method of any of F1-F3, wherein the resting comprises providing a time period in the at least one ground heat exchanger without EEF flow.

F5. The method of any of F1-F4, wherein the active heat exchange and redistribution use different EEF flow rates.

F6. The method of any of F1-F5, wherein the active heat exchange is performed for a first period of time, the redistribution is performed for a second period of time, and the resting is performed for a third period of time (e.g., where the first period of time comprises between 20% and 50% of a selected ground heat exchanger's operation time and the second and third period of time comprise between 50% and 80% of the selected ground heat exchanger's operation time).

F7. The method of any F1-F6, further comprising: directing the EEF to one or more external systems coupled to the ground heat exchangers (e.g., a heat pump loop, outside air exchanger, or solar thermal panels).

F8. The method of any of F1-F7, further comprising: receiving performance data (e.g., EWT, LWT, pressure, flow rate) from at least one of the plurality of ground heat exchangers.

F9. The method of F8, wherein at least one of redistributing, resting, or directing EEF to an external system is based at least in part on the received performance data (e.g., selection of a ground heat exchanger for a particular step is based at least in part on the received data).

F10. The method of any of F1-F9, wherein the plurality of ground heat exchangers comprises at least a first ground heat exchanger (or first group), a second ground heat exchanger (or second group), and a third ground heat exchanger (or third group), and wherein, during a first time period, active heat exchange is performed by the first heat exchanger (or first group) while at least one of the second and third heat exchangers (or groups) is rested or undergoes EEF redistribution.

F11. The method of F10, wherein, during a second time period, active heat exchange is performed by the second heat exchanger (or second group) while at least one of the first and third heat exchangers (or groups) is rested or undergoes EEF redistribution.

F12. The method of F11, wherein, during a third time period, active heat exchange is performed with by third heat exchanger (or third group) while at least one of the first and second heat exchangers (or groups) is rested or undergoes EEF redistribution.

(Group G Embodiments) G1. A method of monitoring a ground heat exchange system, comprising: inserting one or more temporary sensors or measurement tools into a flow path of the ground heat exchange system, monitoring system performance using the one or more temporary sensors or measurement tools during operation of the ground heat exchange system.

G2. The method of G1, wherein the one or more temporary sensors or measurement tools are inserted into the flow path during operation of the ground heat exchange system.

G3. The method of G1 or G2, wherein the one or more temporary sensors or measurement tools are inserted into the ground heat exchange system or a connected lateral through a surface adapter (e.g., an adapter according to any of the Group C Embodiments).

G4. The method of any of G1-G3, wherein the monitored performance comprises one or more of temperature, pressure, and flow.

G5. The method of any of G1-G4, further comprising: receiving at a data logger performance data form the one or more temporary sensors or measurement tools.

G6. The method of any of G1-G5, further comprising: providing power to a device (e.g., controller or permanent sensor) through an adapter of the ground heat exchange system.

G7. The method of any of G1-G6, wherein the system performance is monitored by taking one or more measurements along a depth of a vertical flow channel of the ground heat exchange system (e.g., at a depth of at least 50% of the channel or at the bottom of the channel).

G8. The method of any of G1-G7, wherein the ground heat exchange system is a system according to any of the Group A or Group E Embodiments.

Embodiments are provided for a large diameter HVHF-CGHEX installed in competent bedrock boreholes using a flexible outer tube (3) to separate the EEF from borehole wall where-said outer tube (3) is in direct contact with the borehole wall providing maximum thermal connection; said outer tube (3) is thin, having a wall thickness between 0.050″ and 0.250″, flexible, and comprised of PVC or other similar materials; said outer tube (3) is designed with a burst pressure that greatly exceeds the differential pressure created when elevating the internal level of EEF within outer tube (3) above the external ambient groundwater levels; and said outer tube (3) is sealed at the lower terminal end by folding along the axis and clamping the outer tube (3) in a clamp (4) comprised of two parts containing bolts to draw the parts together to secure, compress and seal the lower extremity of the outer tube (3).

In certain aspects, embodiments are provided to equip and/or convert large diameter cased boreholes drilled and completed by a variety of drilling methods and means in unconsolidated formations to become HVHF-CGHEXs. This can include the connection of an ASUB2L to the top of casing (16). In embodiments, a device (e.g., ASUB2L) for making subsurface connections between a borehole, an installed HVHF-CGHEX (or other GHEX), and lateral piping which provides internal access to the borehole, the GHEX, and the lateral piping from the surface throughout design life is provided. Examples are provided that meet a variety of installation requirements. ASUB2L-O/U (20A/20B) providing over (32)/under (29) lateral connections, and ASUB2L-S/E (21) providing same elevation lateral connections (32 and 29A). One size of ASUB2L to fit 4, 6, and 8″ HVHF-CGHEX diameters, and custom sizes for larger designs.

According to embodiments, a device is provided comprised of two major assemblies—(1) an outer shell (20A/20B/21) and a removable internal spool assembly (23/67). One potential benefit is the ability to bury an ASUB2L below grade/frost that incorporates a surface riser (22) whose length can be varied to rise to the surface, or near surface, where it is covered with a cap, or a DOT rated manhole. Another potential benefit is that an outer shell (20A/20B/21) provides a structural element connecting the vertical wellbore to lateral piping that permits continuous access to the well bore after burial. In the O/U model, the lateral connections are positioned in an over/under configuration and more or less, oriented along the same azimuth. Other orientations are possible by customizing the relative rotation of the two flow chambers (30, 31) along the z-axis. In the S/E model, the lateral connections are located at the same elevation having an azimuth orientation more or less 180 degrees. Modification can be made by adjusting the location of 29A.

In some embodiments, a device is provided comprising an internal spool assembly (23/67) that provides internal connections to one or more components of the HVHF-CGHEX, (or other GHEX). In this example:
(i) said spool facilitates the installation, operation, and removal of the inner tube (6) and other down hole components;
(ii) said spool (23/67) provides connection(s) (35, 41) for various diameter inner tubes which are selected based upon considerations of flow rates, pressure drops and transit time for the EEF;
(iii) said spool separates flow channels;
(iv) said spool provides an insulating layer created with an air gap or space for insulating materials between discs to separate the two flow chambers, reducing unwanted cross-channel heat transfer;
(v) said spool incorporates measuring ports to provide access for the measurement of temperature, pressure, and flow as well as other parameters at the HVHF-CGHEX/GHEX/ASUB2L head;
(vi) said spool incorporates a customizable orifice (43) on the side of the spool assembly (23/67) which may be used to regulate and balance flow for the internal flow channel (A);
(vii) said spool incorporates pass-through ports on the discs of the spool assembly (23/67) to provide sensor access to the two flow channels (A & B) to measure parameters at depth.
(viii) said spool provides unimpeded access through the center tube (25) to measure depth-specific properties of the HVHF-CGHEX inner tube (6) throughout its entire length during various states of operation;
(ix) the ability to actively purge air from the laterals and the top of each HVHF-CGHEX (or GHEX) utilizing a purge port atop the center stem (25) to eliminate trapped air with the potential to create an air block is a benefit; and/or
(x) means are provided to install and remove the spool assembly (23/67) by latching onto the action ring (42) with a setting/pulling tool (not shown) operated from above ground.

A sensor and control system architecture or “Smart System” can be used with active and individual control of each HVHF-CGHEX, or groupings, to maximize overall system performance. Aspects may comprise: real-time, on-board instrumentation at selected or at each HVHF-CGHEX assembly, (comprised of the in-borehole components and the ASUB2L) to monitor record, and report parameters such as temperature, pressure, and flow at various points throughout the selected device; a piping arrangement where each HVHF-CGHEX, or groups of HVHF-CGHEXs, are piped as home runs to one or more distribution and control centers; networked electro-mechanical valves controlling flow to the piping for each HVHF-CGHEX or grouping that can be operated by a user or a control system; a control system which performs active flow management and may direct EEF to the primary heat pump loop, to an outside air exchanger, to solar thermal panels, to selected HVHF-CGHEX, or other such attached devices, all for the purpose of efficiently managing the overall thermal budget within the GeoEE field; and or the use of data from a Smart System in conjunction with ML and AI to intelligently and continually optimize a field's performance to take advantage of changing or external conditions such as advective thermal transport from groundwater moving across the field.

In some embodiments a Surface Control Valve (SCV 174) is built like an embodiment of the ASUB2L center spool assembly (23) and comprises a case (193) and lower connections 197 and 196 to connect to the upper end of pipes 171 and 173, respectively.

In some embodiments a design is provided that fits an ASUB2L-O/U outer shell (20A/20B). The design may, for instance: comprise with two lateral ports (194 and 195) that align with laterals connections 32 and 29, respectively, comprise an internal barrel valve (203) that rotates freely around the radial axis; comprise a removal top (200) to access the barrel valve (203) and all internal seals; comprise internal seals that prevent flow unless the valve openings (204-210) are aligned with their respective ports (194-198); comprise an actuator (202) mounted atop the upper-case disc (200) to shift the position of the barrel valve (203). In certain aspects, a barrel valve (203) can be positioned within the SCV Case (193). It may, for instance, have a minimum of four lateral openings (204-207), in sets of two, oriented at a spacing of approximately 90 degrees radially and positioned to align with lateral ports (194/195), respectively as the barrel valve (203) is rotated to various positions. It may also having three or more internal channels (212) to direct flow from the lateral openings (204-207) to three or more appropriate bottom openings (208-210), oriented at a spacing between 50-110 degrees radially and positioned to align with annular and pipe ports (196-198), respectively as the barrel valve (203) is rotated to various positions. Designs may also include a mid-body O-ring (211) to isolate upper and lower flow channels from ports 194 and 195, an actuator (200) to rotate the barrel valve (203) along its radial axis to align the respective lateral openings (204-207), with the appropriate lateral ports (194/195) and the bottom openings (208-210) with the ports/pipe connections (196-198) to direct EEF into either the lower segment (179) having flow channels A and B or to the upper segment (178) having flow channels C and D; additional power, sensors, and electro-mechanical devices to operate the SCV (174) and interface with a micro-controller or other devices. In some embodiments, the SCV (174) can be configured to alternate flow segments (178/179) according to the cyclic-cylinder pattern being employed.

Benefits of embodiments can include a reduction in ownership and operation risk, which is realized by simplifying the installation, and providing long-term access the borehole and laterals enabling GHEX to be installed, modified, or repaired in tight site locations. This can provide reduced cost to the owner for the same or greater thermal capacity.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-39. (canceled)

40. A system for heat exchange, comprising:
a first tube formed of a flexible material;
a second tube arranged concentrically within the first tube; and
an adapter, wherein the first and second tubes are accessible via the adapter.

41. The system of claim 40, wherein the first tube is radially collapsible and expandable.

42. The system of 40, further comprising:
one or more centralizers or turbulators arranged between the first and second tube.

43. The system of claim 40, wherein the adapter is a subsurface adapter located at least partially below ground.

44. The system of claim 40, wherein a width of the first tube is between 2-3 times as wide as a width of the second tube, or wherein the first tube has a diameter from 6-8 inches and the inner tube has a diameter from 2-4 inches.

45. The system of claim 40, further comprising:
lateral piping.

46. The system of claim 45, wherein the adapter provides a subsurface fluid connection between the first tube and the lateral piping and between the second tube and the lateral piping.

47. The system of claim 40, further comprising:
a ground borehole having an outer wall, wherein the first tube is in direct contact with the borehole wall, and wherein the flexible material of the first tube conforms to the borehole wall.

48. The system of claim 40, wherein the first and second tubes are arranged vertically and underground to form a ground heat exchanger.

49. The system of claim 40, wherein at least one of the first and second tubes is vertically segmented by a partition to form an upper heat exchanging region and a lower heat exchanging region.

50. The system of claim 49, wherein the partition comprises a ported inflatable packer.

51. The system of claim 49, further comprising:
a control valve,
wherein the control valve has a first setting that restricts fluid flow to the upper region, and
wherein the control valve has a second setting that enables fluid flow in the lower region.

52. The system of claim 40, wherein the flexible material comprises PVC in combination with one or more plies of material wrap.

53. The system of claim 40, wherein the adapter is connected to the top of the first tube and the top of the second tube to form a water-tight seal to the first and second tubes.

54. The system of claim 40, wherein the adapter comprises:
an outer shell, wherein the outer shell has a first fluid port and a second fluid port.

55. The system of claim 40, wherein the adapter comprises:
one or more sensors or monitoring units located within the adapter.

56. The system of claim 40, wherein the adapter comprises:
an internal spool assembly

57. The system of claim 56, wherein the internal spool assembly is removable.

58. A heat exchange system, comprising:
a plurality of interconnected ground heat exchangers according to claim 40.

59. The heat exchange system of claim 58, further comprising:
a fluid distribution and control unit; and
a plurality of pipes interconnecting the plurality of ground heat exchanges with the distribution and control unit.
